(19) United States
(12) Patent Application Publication
(10) Pub. No.: US 2024/0361229 A1
(43) Pub. Date: Oct. 31, 2024

(54) FLOW CYTOMETRY SYSTEM WITH APPLIED BACK PRESSURE TO WASTE FLOW

(71) Applicant: SARTORIUS BIOANALYTICAL INSTRUMENTS, INC., Bohemia, NY (US)

(72) Inventors: Edward MORRELL, Morrison, CO (US); Heinrich FELDOTTE, Göttingen (DE); Richard ESSER, Bovenden - Eddigehausen (DE)

(21) Appl. No.: 18/688,322

(22) PCT Filed: Sep. 3, 2021
(86) PCT No.: PCT/US2021/049013

§ 371 Date: Feb. 29, 2024

(51) Int. Cl. G01N 15/1409; G01N 15/1434

(52) U.S. Cl. CPC G01N 15/1409; G01N 15/1434

(57) ABSTRACT

A flow cytometry evaluation system includes a sample effluent system with an effluent collection vessel with an effluent fluid inlet to receive an effluent of the fluid sample exiting the investigation zone during a flow cytometry evaluation; and an effluent fluid conduction path from the investigation zone to the effluent fluid inlet. A pressurized gas delivery system in fluid communication with the sample effluent system applies pressurized gas to the fluid sample effluent system to impede fluid flow through the effluent fluid conduction path toward the effluent fluid inlet during a flow cytometry investigation

### BACKGROUND

Flow cytometry is an analytical technique for evaluating a fluid sample for the presence of target particles of interest. Flow cytometry involves subjecting a flow of a fluid sample to a stimulus (typically light, such as from a laser) detecting a response (typically response radiation) and analyzing the response to identify occurrences of the target particles. Response detection capabilities may include detection of one or more radiation response properties, which may include detection of one or more of light scatter properties, such as forward scatter light and/or side scatter light, and detection for one or more fluorescent emission signatures of fluorescent stains that may be added to fluid samples to fluorescently label particular features of target particles. Flow cytometry is a common technique used to evaluate for the presence of cells and other similarly sized particles, which are often of a size in a range of from 2 to 20 microns. Flow cytometers used for such applications commonly include both light scatter detection with multiple light scatter detectors to permit detection of different light scatter properties and fluorescent emission detection capabilities with multiple fluorescent emission detectors to permit detection of multiple different fluorescent emission signatures provided by different fluorescent stains. Flow cytometry evaluation systems may also combine a flow cytometer with an autosampler that is capable of automated processing of sample trays containing many fluid samples for automated delivery of the fluid samples sequentially to the flow cytometer to perform sequential flow cytometry investigations of the fluid samples. Such systems are widely used in analyzing cells and particles of similar size, and provide a convenient and cost effective technique for flow cytometry analysis of many fluid samples in a relatively short amount of time.

More recently flow cytometers have been developed with capabilities to analyze for much smaller particles, such as virus particles (virions), virus-like particles and extracellular vesicles, including exosomes, and other similarly sized particles. For convenience, such particles are referred to herein generally as virus-size particles. Such virus-size particles may often be in a range of from 20 nanometers to one micron in size, with particle sizes smaller than 200 microns or even smaller than 100 microns being very common. When evaluating fluid samples for the presence of such virus-size particles by flow cytometry, techniques and practices that work well for flow cytometry analysis of cells and similarly-sized particles often do not translate well for analysis of virus-size particles. An example of a flow cytometer designed for analysis of such virus-size particles is the Virus Counter 3100 flow cytometer (Sartorius Stedim Biotech), which processes much smaller fluid samples at much lower flow rates and uses only fluorescent emission detection, without light scatter detection. Combining flow cytometers with an autosampler with flexibility to analyze for virus-size particles in robust and accurate systems that are also easy to use, maintain and service has been challenging, and there remains a significant need for such systems.

### SUMMARY

A first aspect of this disclosure concerns flow cytometry evaluation systems with applied back pressure to impede flow of a fluid sample toward an effluent collection vessel (e.g., waste container). In various implementations, such a flow cytometry evaluation system may comprise:
a flow cytometry investigation system comprising an investigation zone configured to receive during a flow cytometry evaluation a flow of a fluid sample for flow cytometry investigation in the investigation zone for the presence of particles in the flow of the fluid sample:
a sample effluent system, wherein the sample effluent system comprises:
   an effluent collection vessel with an effluent fluid inlet to receive in the effluent collection vessel an effluent of the fluid sample exiting the investigation zone during a flow cytometry evaluation; and
   an effluent fluid conduction path from the investigation zone to the effluent fluid inlet; and
   a pressurized gas delivery system in fluid communication with the sample effluent system, wherein the pressurized gas delivery system is configured to apply pressurized gas to pressurize at least a portion of the fluid sample effluent system at an applied gas pressure that provides a positive back pressure in the effluent fluid conduction path impeding fluid flow through the effluent fluid conduction path toward the effluent fluid inlet during a flow cytometry investigation.

The flow cytometry evaluation systems of the first aspect have been found to be advantageously adaptable in combination with an autosampler, providing flexibility for use of autosamplers with flow cytometers designed to analyze fluid samples for the presence of virus-size particles to provide accurate and robust flow cytometry evaluation systems that are convenient to use, maintain and service and that provide flexibility for a variety of system configurations, including stacked configurations with the autosampler advantageously positioned at a higher location in the stacked structure than the flow cytometry investigation system.

A second aspect of this disclosure concerns methods for flow cytometry evaluation in which during a flow cytometry investigation of a fluid sample an applied back pressure impedes flow of the fluid sample toward an effluent collection vessel (e.g., waste container). In various implementations, such a method may comprise:
flowing a fluid sample through an investigation zone of a flow cytometry investigation system with a downstream end of the investigation zone being in fluid communication with a sample effluent system comprising:
   an effluent collection vessel with an effluent fluid inlet to receive in the effluent collection vessel an effluent of the fluid sample exiting the investigation zone during a flow cytometry evaluation; and
   an effluent fluid conduction path from the investigation zone to the effluent fluid inlet:
performing a flow cytometry investigation of a flow of the fluid sample in the investigation zone:
conducting an effluent of the fluid sample exiting the investigation zone through the effluent fluid conduction path to the effluent collection vessel where the effluent of the fluid sample is collected; and
during the flowing the fluid sample through the investigation zone, applying pressurized gas to pressurize at least a portion of the fluid sample effluent system at an applied gas pressure that provides a positive back pressure in the effluent fluid conduction path impeding fluid flow through the effluent fluid conduction path toward the effluent fluid inlet of the effluent collection vessel.
   The method of the second aspect may be performed using the flow cytometry evaluation system of the first aspect.

Various other feature refinements and additional features are applicable to each of these and other aspects of this disclosure, as disclosed in the description below (including in the numbered Example Implementation Combinations), the figures and the appended claims. These feature refinements and additional features may be used individually or in any combination within the subject matter of the aspects summarized above or other aspects disclosed herein. Any such feature refinement or additional feature may be, but is not required to be, used with any other feature or a combination of features disclosed herein.

### BRIEF DESCRIPTION OF THE DRAWINGS

FIG. 1 is a schematic illustrating general features of an example flow cytometry evaluation system of a first aspect of this disclosure.

FIG. 2 is a perspective view of an example instrument module including an example configuration of the flow cytometry evaluation system of FIG. 1 in a stacked structure with an autosampler disposed at a higher location than a flow cytometry investigation zone.

FIG. 3 is a partial perspective view of a portion of the instrument module of FIG. 2 with a side access panel removed to illustrate a slidable shelf feature to support a flow cytometry investigation system.

FIG. 4 is partial perspective view of a portion of the instrument module of FIG. 2 illustrating some reagent and waste collection container connection configurations.

FIG. 5 is a partial perspective view of a portion of a slidable shelf and flow cytometry investigation system of the instrument module of FIG. 2.

FIG. 6 is a partial top view of features of a flow cytometry investigation system of the instrument module of FIG. 2.

FIG. 7 is a fluid fluidics diagram of the flow cytometry evaluation system of the instrument module of FIG. 2.

FIG. 8 is a schematic of a temperature control system of the flow cytometry evaluation system of the instrument module of FIG. 2.

FIG. 9 illustrates an example timeline for obtaining a temperature determination data set in the temperature control system of FIG. 8.

FIG. 10 shows a side view of a common optical component mounting platform for mounting components of an optical processing system of the flow cytometry investigation system of the instrument module of FIG. 2, including a temperature sensor and resistive heating elements of the temperature control system of FIG. 8.

### DETAILED DESCRIPTION

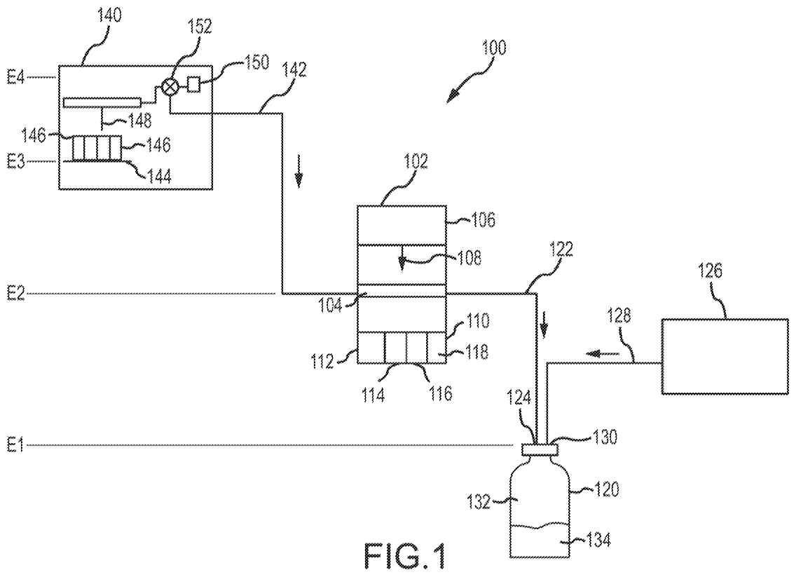

FIG. 1 illustrates an example embodiment of a flow cytometry evaluation system 100 with applied gas pressure to provide a positive back pressure in an effluent fluid conduction path impeding fluid flow from a flow cytometry investigation zone to an effluent collection vessel, for example to partially or fully counteract gravity-driven fluid flow effects during flow cytometry evaluations. The flow cytometry evaluation system 100 illustrated in FIG. 1 includes a flow cytometry investigation system 102 where fluid samples are subjected to investigations as part of a flow cytometry evaluation. The flow cytometry investigation system 102 includes an investigation zone 104 that provides a controlled flow conduction path for flow of fluid samples for investigation, a radiation delivery system 106 to provide input light 108 to the investigation zone 104 for investigation of the fluid sample, and a radiation detection system 110 to detect response radiation from a fluid sample passing through the investigation zone 104 that is subjected to the input light 108 as part of a flow cytometry evaluation. The radiation delivery system 106 may include one or multiple light sources to provide one or multiple different beams of light to the investigation zone 104. Such different beams of light may have different properties (e.g., different wavelength bands of light) to investigate for different properties of particles in fluid samples flowing through the investigation zone 104. For example, the radiation delivery system 106 may include one or more lasers and/or other light sources such as LEDs, providing light with one or more particular wavelengths to stimulate one or more radiation responses to be detected by the radiation detection system 110. When the radiation delivery system 106 contains multiple different light sources, such light sources may be spaced along the investigation zone 104 and sufficiently shielded from one another to minimize interference between different light sources. The investigation zone 104 may be configured to receive a flow of fluid sample by itself or may be configured to receive a hydrodynamically focused flow of fluid sample surrounded by a sheath fluid. The investigation zone 104 may be provided as a passage through a flow cell of a flow cytometer. The investigation zone 104 may be a continuous length of transparent conduit or may comprise discontinuous transparent portions of a longer conduit system. The radiation detection system 110 may include one or more different radiation detectors to detect different response radiation properties coming from the investigation zone 104. Such radiation detectors may for example be selected from the group of photomultiplier tubes, silicon photomultipliers, avalanche photodiodes and selection photodiodes, with photomultiplier tubes often being preferred when there is a desire to detect and process very weak signals. When multiple radiation detectors are included, the radiation detectors may detect for signals in different wavelength ranges or may be positioned to receive signals from different directions. The response radiation detected by the radiation detection system 110 may include one or more fluorescent signals from fluorescent labels staining particles and/or may also include light scatter, for example forward scatter light and/or side scatter light. When detecting particles of a size on the order of cells (e.g., about 2 to 20 microns), forward scatter light detection and/or side scatter light detection may often be used to assist with particle identification, and with detection of fluorescent signals from one or more fluorescent labels providing information to identify particular properties of the particles. When detecting particles of a size on the order of virus particles (e.g., about 20 nanometers to about one micron) detection by the radiation detection system 110 may include only detection of fluorescent signals from fluorescent labels staining the virus-size particles to identify particle attributes. In the example illustrated in FIG. 1, the radiation detection system 110 is shown including four radiation detectors, including a first detector 112 to detect for a first fluorescent signal, a second detector 114 to detect for a second fluorescent signal, a third detector 116 to detect for forward scatter light, and a fourth detector 118 to detect for side scatter light. As will be appreciated, the radiation detection system 110 may include fewer than or more than the four example radiation detectors as illustrated in FIG. 1. The different radiation detectors may be appropriately oriented and spaced along the investigation zone 104 for effective detection of the desired response radiation.

The flow cytometry evaluation system 100 includes a sample effluent system for handling sample effluent (waste) exiting the investigation zone 104 from a flow cytometry investigation in the flow cytometry investigation system 102. The sample effluent system as illustrated in FIG. 1 includes an effluent collection vessel 120 to receive effluent of the fluid sample from the investigation zone 104 and an effluent fluid conduction path 122 to conduct the effluent of the fluid sample from the investigation zone 104 to the effluent collection vessel 120. The effluent collection vessel 120 has an effluent fluid inlet 124 through which the effluent of the fluid sample enters the effluent collection vessel 120. When reference is made to a sample effluent system, such a system is configured to conduct effluent of the fluid sample from an investigation zone and to collect the effluent of the fluid sample. However, a sample effluent system is not necessarily limited to conduction and collection of only effluent of the fluid sample, and may conduct and collect other liquid effluent(s) (e.g., waste liquids) whether or not exiting from a flow cytometry investigation zone and whether or not mixed with effluent of the fluid sample. As can be appreciated, when a flow cytometry investigation in the flow cytometry evaluation system 100 of FIG. 1 includes the use of a sheath fluid surrounding a fluid sample, effluent fluid from the investigation zone 104 that is collected in the effluent collection vessel 120 will include a mixture with effluent of fluid sample and effluent of the sheath fluid. Additionally, if a fluid sample is pushed to and through the investigation zone 104 by a drive liquid, the effluent of the drive liquid exiting the investigation zone 104 will also be collected as effluent fluid in the effluent collection vessel 120.

As illustrated in FIG. 1, the flow cytometry evaluation system 100 includes a pressurized gas delivery system 126 in fluid communication with the effluent collection vessel 120 to apply pressurized gas from a pressurized gas supply line 128 to pressurize the effluent collection vessel 120. In the flow cytometry evaluation system 100 illustrated in FIG. 1, the pressurized gas is delivered to the effluent collection vessel 120 through a gas inlet 130 positioned at the top of the effluent collection vessel 120, similar to positioning of the effluent fluid inlet 124. As shown in FIG. 1, the effluent collection vessel 120 has a pressurized gas headspace 132 at an applied gas pressure provided by the pressurized gas supply line 128 from the pressurized gas delivery system 126. As can be appreciated, as the effluent collection vessel 120 fills with waste liquid 134, the size of the pressurized gas headspace 132 will decrease, but will be maintained at the applied gas pressure provided by the pressurized gas supply line 128, as regulated by the pressurized gas delivery system 126. The effluent collection vessel 120 may be fitted with a pressure relief vent to permit venting of pressurized gas from the pressurized gas headspace 132 as the level of the waste liquid 134 rises in the effluent collection vessel 120. Alternatively, the pressurized gas delivery system 126 may be configured to bleed pressure as necessary to maintain a desired level of applied gas pressure in the effluent collection vessel 120.

As shown in FIG. 1, the flow cytometry evaluation system 100 includes a sample delivery system in the form of an autosampler 140 to sequentially withdraw fluid samples from a plurality of sample containers 146 and deliver the plurality of fluid samples in a sequence to a fluid sample conduction path 142 for sequential conduction of the fluid samples to the investigation zone 104 to perform sequential flow cytometry investigations of the fluid samples. In the illustration of FIG. 1, the autosampler 140 has a sample receiving location 144, in the form of a platform, where the plurality of sample containers 146 may be received for sequential processing. The plurality of sample containers 146 may be provided, for example, in a multi-container tray. Such a multi-container tray may be in the form of a multi-well plate with the fluid sample containers 146 being wells of the plate. Such a multi-well plate may have any number of wells, and may be, for example, a 24-, 48-, 96- or larger well plate. Such a multi-container tray may alternatively be in the form of a vial tray with a plurality of vials as the sample containers 146 received in receptacles of a tray. Such a vial tray may include any number of vial receptacles and any number of vials received in the vial receptacles. Such a vial tray may include for example 24, 48, 96 or a larger number of sample vials.

The example autosampler 140 illustrated in FIG. 1 includes a sample delivery probe 148, for example, in the form of a hypodermic needle, configured to be inserted into the plurality of sample containers 146 one at a time to withdraw fluid sample from the plurality of sample containers 146 in a sequence for delivery to the fluid sample conduction path 142 for conduction to the investigation zone 104 for sequential flow cytometry investigations of the fluid samples. As is typical with autosamplers, the sample delivery probe 148 and the plurality of fluid containers 146 are indexed and movable relative to each other to permit the sample delivery probe 148 to interact with each of the different ones of the plurality of fluid containers 146. For example, the plurality of fluid containers 146 may remain stationary while the sample delivery probe 148 moves spatially over the area of the plurality of fluid containers 146 and moves vertically up and down to permit penetration into each of the sample containers 146, and, in turn, to withdraw the fluid samples from the sample containers 146 one at a time in a sequence. In another example, the sample delivery probe 148 may remain stationary while the sample receiving location 144 moves relative to the sample delivery probe 148. The sample receiving location 144 may be configured to change elevations to provide penetration of the sample delivery probe 148 inside of a sample container or the sample delivery probe 148 may be on a mechanism that raises and lowers the sample delivery probe 148 to permit penetration inside of each sample container.

The example autosampler 140 is further configured with a sample holding zone 150 in which a fluid sample withdrawn from a sample container is initially delivered to from the sample delivery probe 148 through a multi-positional valve 152 positioned to fluidly connect the sample delivery probe 148 with the fluid sample holding zone 150 and to fluidly isolate the sample delivery probe 148 and the fluid sample holding zone 150 from the fluid conduction path 142 to the investigation zone 104. After a fluid sample has been loaded into the sample holding zone 150, then the multi-positional valve 152 may be changed to fluidly isolate the fluid sample holding zone 150 from the sample delivery probe 148 and to fluidly connect the fluid sample holding zone 150 with the investigation zone 104, permitting permit the fluid sample to be pushed from the sample holding zone 150 through the multi-positional valve 152 and the fluid sample conduction path 142 to the investigation zone 104 for flow cytometry investigation of the fluid sample. Use of the fluid sample holding zone 150 to initially receive a fluid sample for processing permits separation of, and independent control over, the operation to remove a desired volume of a fluid sample from a fluid container 146 and conduction of that desired volume of the fluid sample to and through the investigation zone 104. As can be appreciated, with the multi-positional valve 152 positioned to conduct flow of the fluid sample from the fluid sample holding zone 150 to the investigation zone 104 for a flow cytometry investigation, the fluid sample holding zone 150 and the flow path through the multi-directional valve make up a part of the fluid sample conduction path 142 to the investigation zone 104. Also, when the multi-positional valve 152 is positioned to conduct a fluid sample from the fluid sample holding zone 150 to the investigation zone 104, the fluid sample conduction path 142, the investigation zone 104, the effluent fluid conduction path 122 and the effluent collection vessel 120 all comprise a pressurized fluidics system during a flow cytometry investigation, and with fluid flow through the fluidics system in a direction toward the effluent collection vessel 120 being impeded by positive back pressure from the applied gas pressure in the effluent collection vessel 120 provided by the pressurized gas supply line 128 from the pressurized gas delivery system 126.

The back pressure applied by the pressurized gas supply line 128 to the effluent collection vessel 120 provides several advantages. Typical flow cytometry systems often have an investigation zone located at a higher elevation than a waste tank into which fluid sample is collected after exiting the investigation zone. Flow from the investigation zone to the waste tank is aided by gravity. However, such gravity-aided drainage from the investigation zone can apply a suction through the investigation zone and fluidics upstream of the investigation zone, in the nature of a siphon-type effect, which can make control of flow rate through the investigation zone more difficult. This is not typically a significant problem with flow cytometers designed primarily for detecting and evaluating particles of a size on the order of cells, as small variations in flow rate typically do not significantly affect flow cytometry results. However, when operating at very low flow rate, for example on the order of 400 nanoliters per minute to 3000 nanoliters per minute, often used for flow cytometry evaluation of very small particles such as virus-size particles, such gravity-induced flow effects may become more problematic with respect to both flow control and accuracy of flow cytometry results. By providing a positive back pressure through the application of the pressurized gas supply line 128, such gravity effects can be mostly reduced or eliminated in a system such as illustrated in FIG. 1. Preferably, the back pressure that is applied is at least as large as, and more preferably larger than, a gravity-induced pressure in the system. As can be appreciated, such gravity-induced pressure during flow cytometry may be equal to a liquid head pressure exerted by a liquid mass between elevations of the liquid mass in the fluid flow path through the flow cytometry evaluation system 100 during a flow cytometry evaluation. Such a liquid head pressure may be exerted by fluid sample, sheath fluid and/or drive liquid in the fluid flow path. Such fluids are typically aqueous liquids that have a density close to, even if not equal to, the density of water and accordingly exert a head pressure close that of water. In one preferred implementation, the back pressure that is applied is at least as large as, and more preferably larger than a head pressure of a water column of vertical height equal to a difference in elevation between the effluent fluid inlet 124 and a lowest elevation of the investigation zone 104. Even more preferably, the back pressure that is applied is at least as large as, and still more preferably larger than, a head pressure of a column of water of vertical height equal to a difference in elevation between the effluent fluid inlet 124 and a highest elevation in the fluid path through which the fluid sample is conducted to and through the investigation zone 104 and to the effluent collection container 120 in connection with a flow cytometry investigation. Although the siphon-type effects can be reduced by providing a pressure break immediately after an investigation zone, greater control over pressure effects is provided by application of a positive back pressure to counteract gravity-induced flow effects in a flow cytometry system such as that illustrated in FIG. 1. Also, gravity-induced suction effects within the fluidics system during flow cytometry investigation can lead to development of more and larger air bubbles in fluid samples, which can be detrimental to uniform liquid flow and flow cytometry performance. Bubble removal devices have been used in flow cytometers to reduce these problems, but bubble development remains a problem even using such devices. Application of a positive back pressure through the system can counteract gravity-induced suction effects to reduce development of more or larger air bubbles. Additionally, the added backpressure results in a higher pressure system in the investigation zone 104 and the fluid sample conduction path 142 during flow cytometry evaluation and further reduces potential for development of more or larger air bubbles in the system. Moreover, application of a back pressure from the effluent system provides greater flexibility in flow cytometry system design. A common design for systems integrating an autosampler with a flow cytometer is to locate the autosampler at a lower elevation or at about the same elevation as the flow cytometer. However, there can be operational and maintenance advantages to locating the autosampler at a higher elevation than the flow cytometer, but doing so presents fluidics problem in terms of the gravity head pressure of the liquid column applying extra pressure to push the fluid sample, which complicates flow control. With such gravity-induced flow effects addressed through application of positive back pressure as illustrated in FIG. 1, greater flexibility is available for flow cytometry system design to achieve other advantages.

One advantageous design that is facilitated by use of the positive back pressure as illustrated in FIG. 1 is a stacked system design in which an autosampler 140 is positioned in an elevated stack position relative to a flow cytometry investigation system 102. A stacked design provides an advantage of a smaller footprint relative to a side-by-side arrangement of an autosampler and flow cytometer. A natural positioning in a stacked design is to locate the autosampler at a lower elevation and the flow cytometer at a higher elevation, in part to avoid detrimental gravity-induced flow effects on fluid sample flow from the autosampler to the investigation zone. However, from a user standpoint, having the autosampler located at a higher position in a stacked design permits more convenient access to load trays of fluid samples for processing and to remove trays at the end of processing, to observe and change reagent containers as needed in the autosampler, and to observe as needed autosampler performance by a standing person, without having to stoop or bend over. The flow cytometry investigation system is typically accessed only for servicing and maintenance, which may involve removing and replacing and/or adjusting componentry of the flow cytometry investigation system. Having that componentry at a lower level makes it easier to provide access to remove and service such componentry. FIG. 1 illustrates various elevations within the flow cytometry evaluation system 100. In the example of FIG. 1, E4 is a highest elevation in the fluid sample conduction path 142, which is in the fluid sample holding zone 150 when the multi-positional valve 152 is positioned for conduction of a fluid sample from the fluid sample holding zone 150 to the investigation zone 104 for flow cytometry investigation. E3 is an elevation of the sample receiving location 144 of the autosampler 140, which is higher than an elevation E2 of the investigation zone 104. Elevation E2 is higher than an elevation E1 of the effluent fluid inlet 124 of the effluent collection vessel 120. In general, this design is well-suited for a stacked design configuration with the autosampler 140 positioned at a higher position than the flow cytometry investigation system 102. The facilitates versatility of design in orientation of the investigation zone 104. For example, the investigation zone 104 may be oriented to extend horizontally in a longitudinal direction of the flow path through the investigation zone 104, or the investigation zone 104 may be oriented with a vertical incline to the longitudinal direction of the flow path, for example if more convenient for instrument design. Such a vertical incline could be on a vertically climbing or descending slope in the flow direction or could be fully vertical (90° angle relative to horizontal) with flow in an upward or downward direction. The application of back pressure as illustrated in FIG. 1 may counteract gravity-induced flow effects as a consequence of vertical inclination of the flow path through the investigation zone 104. As can be appreciated, when the investigation zone 104 is oriented with a horizontal flow path, there will be little difference between a highest elevation in the investigation zone 104 and a lowest elevation in the investigation zone, but the difference between the highest and the lowest elevations in the investigation zone 104 may be much larger when the flow path of the investigation zone 104 includes a vertical incline.

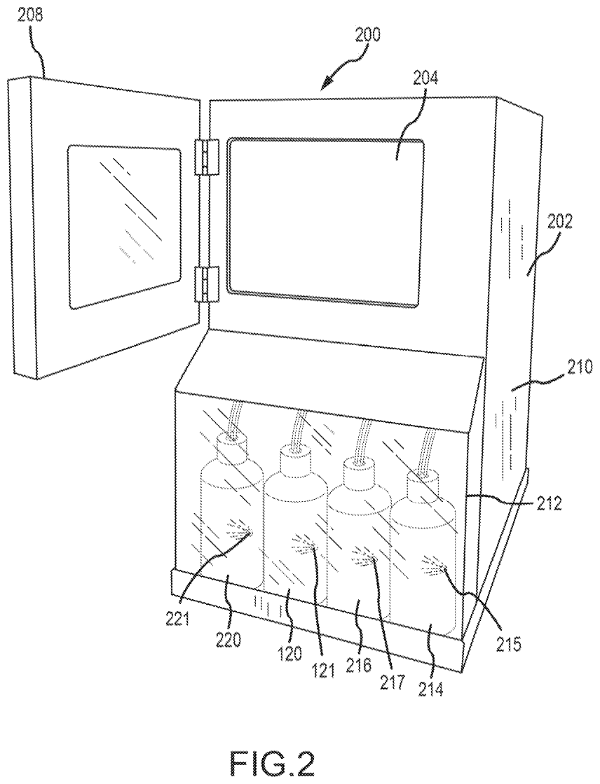

Reference is now made to FIGS. 2-7 in combination with FIG. 1. FIGS. 2-7 illustrate features of an exemplary single-unit instrument module 200 including one example configuration of the general flow cytometry evaluation system 100 of FIG. 1, with the autosampler 140 and the flow cytometry investigation system 102 in a stacked configuration. By single-unit it is meant that the instrument module is in one integrated structure movable as a single piece and not comprised of separate units not physically connected together, and preferably with all autosampler and flow cytometer componentry supported on a common support frame and in a common housing. In particular, the autosampler 140 is positioned at a higher location in the stack than the flow cytometry investigation system 102, and includes the pressurized gas delivery system 126 to provide a back pressure to fluid flow through the fluidics system during performance of flow cytometry investigations of fluid samples. Reference numerals for like features illustrated in FIGS. 2-7 are the same as used for the features of FIG. 1.

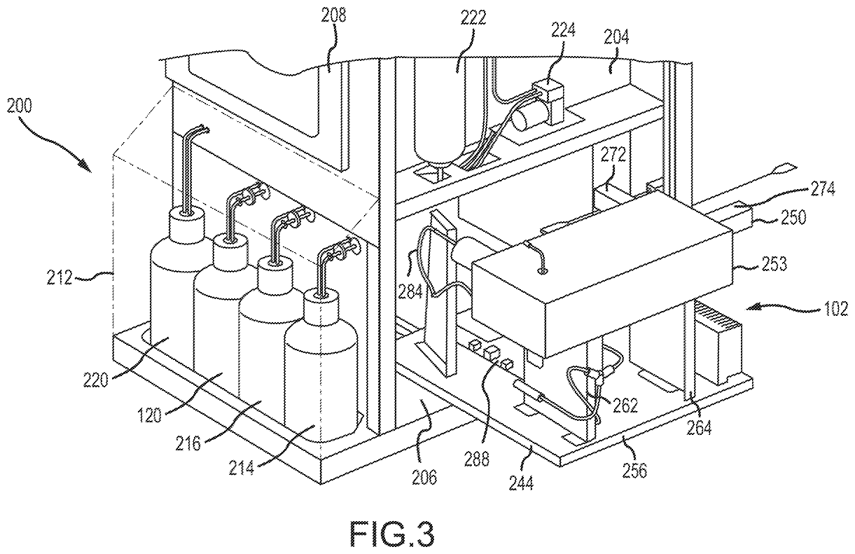

Referring first to FIGS. 2-4 in combination with FIG. 1, the flow cytometry instrument module 200 includes a housing 202 in which an upper compartment 204 contains componentry of the autosampler 140 and a lower compartment 206 (visible in FIG. 3), which contains componentry of the flow cytometry investigation system 102. The autosampler 140 disposed in the upper compartment 204 includes the receiving location 144 for receiving a plurality of sample containers 146 and the sample delivery probe 148 configured to interface with the sample containers 146 to withdraw fluid samples for sequential flow cytometry investigations. The autosampler 140 disposed in the upper compartment 204 may also include one or more containers with liquid reagents used with operation of the autosampler 140, such as cleaning or rinse liquids. The housing 202 includes a hinged door 208 providing access to a user to load trays of fluid samples into the autosampler 140 for processing, to remove processed trays following flow cytometry evaluation of the fluid samples, and to replace or refill containers with reagents used by the autosampler 140. The door 208 has a window through which a user may observe operation of the autosampler 140 during performance of a flow cytometry evaluation. The flow cytometry investigation system 102 in the lower compartment 206 is not normally accessed by a user during a flow cytometry investigation. The housing 202 includes a removable member in the form of a removable side access panel 210, which may be moved to provide access into the lower compartment 206, for example, to perform maintenance or service on the flow cytometry investigation system 102. FIG. 3 shows the instrument module 200 with the access panel 210 removed to provide access into the lower compartment 206. In an alternative configuration the access panel 210 could be on a hinged connection, rather than being fully removable. Removal of the side access panel 210 also provides access into the upper the upper compartment 204 for maintenance and service of componentry in the upper compartment 204. Also, an access door or panel may also be provided on the side of the housing 202 opposite the access panel 210, for example to provide additional access into the upper compartment 204 for convenient access to the autosampler 140 for maintenance and servicing of the autosampler 140. For example, a movable cover member, such as separate access panel, may be provided on the side of the housing 202 opposite the access panel 210 to provide convenient maintenance and service access to the autosampler 140 in the upper compartment 204. It should be understood that references to upper and lower compartments are references only to separate spaces within the housing, with the space of the upper compartment being higher up in the housing relative to the space of the lower compartment. Reference to those spaces as compartments does not indicate that the spaces of the respective compartments are necessarily isolated from each other within the housing 202 by a physical barrier between them.

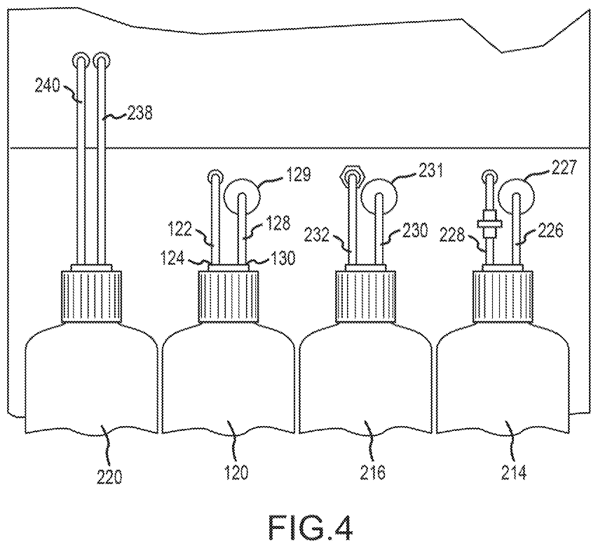

The instrument module 200 also includes a front compartment 212, located in front of the lower compartment 206, in which are disposed fluid containers to hold reagent liquids for use during a flow cytometry evaluation and to receive waste liquids from operation of the flow cytometry evaluation system 100. A first container 214 can be a reagent container for holding sheath liquid for hydrodynamically focusing fluid sample for flow cytometry investigation in the investigation zone 104. A second container 216 can be a reagent container for holding drive liquid for pushing fluid samples to and through the investigation zone 104 during a flow cytometry investigation. A third container can be a waste container in the form of the effluent collection vessel 120, for collecting effluent of the fluid sample exiting the investigation zone 104 during a flow cytometry investigation. A fourth container 220 can be a waste container for collecting waste fluid used in operation of the autosampler 140, for example, to flush and clean components of the autosampler 140 between fluid samples. The effluent collection vessel 120 is pressurized with an applied gas pressure from pressurized gas provided through the pressurized gas line 128 from the pressurized gas delivery system 126, which in the example instrument module 200 includes a pressurized tank 222 that is pressurized by a gas compressor 224. The pressurized gas will typically be air, but could be another pressurized gas, such as nitrogen, if preferred. As an alternative, the pressurized gas delivery system 126 could include a connection to an external pressurized gas source, rather than having an on-board compressor, or could operate solely from a pressurized gas container. As seen in FIG. 4, pressurized gas is delivered to the first container 214 through a gas feed line 226 and sheath liquid is pushed out of the first container 214 through an outlet line 228. The second and fourth containers 216 and 220 are not pressurized. The second container 216 is connected to an air inlet line 230 to permit entry of filtered air into the second container 216 for pressure equalization as drive liquid is removed from the second container 216 through outlet line 232 during processing. The pressurized gas is delivered to the effluent collection vessel 120 through the pressurized gas supply line 128, and waste liquid, including effluent of fluid samples and sheath liquid, are delivered to the effluent collection vessel 120 through the effluent fluid conduction path 122 from the investigation zone 104. The fourth container 220 is not pressurized and receives waste liquid from the autosampler 140 through two waste inlet lines 238 and 240.

The front compartment 212 provides a receiving location for receiving the containers 214, 216, 120 and 220 each in a different received position for fluid connections within the flow cytometry evaluation system 100. As seen best in FIG. 2, the instrument module 200 includes a light illumination system that illuminates an interior space within each of the containers 214, 216, 120 and 220. As seen in FIG. 2, the containers 214, 216, 120 and 220 are each back-lit by a separate lighting element 215, 217, 121 and 221 of the light illumination system. Such lighting elements may include for example, a light-emitting diode (LED) (preferably), incandescent light, fluorescent light or other light source. As illustrated in FIG. 2, each of the lighting elements 215, 217, 121 and 221 are located inside the front compartment 212 behind each container, to shine into an interior space of each of the containers 214, 216, 120 and 220. This advantageously permits the user observing the instrument module 200 from the front to easily discern liquid levels within the containers. In particular, the user can quickly and easily discern an extent to which a container is filling with liquid or emptying of liquid to anticipate servicing needs to either fill a container with reagent (sheath liquid or drive liquid) or to empty out waste liquid (effluent of the fluid sample or autosampler waste liquid). As will be appreciated, a light illumination system may be configured differently to that illustrated in FIG. 2, provided that the light illumination system adequately illuminates the interior spaces of the containers 214, 216, 120 and 220 to permit a person to readily observe liquid levels within those containers. For example, the light illumination system could include an illuminated light strip that runs behind all containers. As other examples, lighting elements could be oriented to shine upward into containers from below, downward into containers from above, or angled upward into containers from lighting elements in front of an near the bottoms of the containers. As will be appreciated, the containers 214, 216, 120 and 220 should be made of sufficiently transparent material to permit easy observation of liquid levels. Additionally, the front compartment 212 is covered by a housing that is optically transparent (e.g., of light transmissive plastic material) at least on the front portion of the front compartment 212 so that an observer stationed in front of the instrument module 200 can readily observe the containers 214, 216, 120 and 220 and the liquid levels within those containers. In the illustrated example of FIG. 2, the front compartment 212 is conveniently located in front of the lower compartment 206 and below an elevation of the upper compartment 204, providing convenient visual observation of the containers 214, 216, 120 and 220 and without impairing access to the upper compartment 204.

Also, as seen best in FIG. 4, each of the gas supply line 128, the air inlet line 230, and the gas feed line 226 has an in-line filter 121, 231 and 227, respectively. The filters 227 and 231 filter pressurized gas flow (typically air) delivered to the first container 214 and second container 216 to prevent contamination of sheath fluid and drive liquid, respectively, with dust particles that may be carried by the gas. The filter 129 filters pressurized gas flow (typically air) into and out of the effluent collection vessel 120. During normal operation, gas flow will generally be in a direction out of the effluent collection vessel 120 as it fills with effluent liquid from flow cytometry investigations, and the filter 129 filters out viral particles that could be entrained in the exiting gas and could otherwise pose a safety hazard. Gas flow into the effluent collection vessel 120 may occur, for example, during initial pressurization of the effluent collection vessel 120 to apply the desired level of back pressure ready for performance of flow cytometry evaluations. Also, the filter 129 may serve an additional safety function by being made of a hydrophobic material that acts as a block to liquid flow through the filter 129 if the effluent collection vessel should fill with aqueous effluent liquid to the level of the filter 129, and flow sensors monitoring fluid flows through the fluidics system of the flow cytometry investigation system 102 will sense the flow blockage, leading a control system to discontinuance of all additional fluid flow through the flow cytometry evaluation system 100 toward the effluent collection vessel 120 until the blockage is removed, for example by emptying or changing out the effluent collection vessel 120.

As seen in FIG. 3, the components of the flow cytometry investigation system 102 are supported on a translationally mounted member in the form of a slidable shelf 244 that is slidably supported on a sliding system, for example, on sliding rails such as those commonly used for cabinet drawers or slidable cabinet shelving. The slidable shelf 244 is translatable between a first position in which the slidable shelf 244 is fully retracted into the housed internal space of the lower compartment 206 and a second position in which the slidable shelf 244 at least partially extends outside of the lower compartment 206 and with at least a portion of the flow cytometry investigation system 102 disposed outside of the housed interior space of the lower compartment 206. As can be appreciated, the first position would be the normal position with the flow cytometry investigation system 102 fully contained in the housed interior space within the lower compartment 206 for normal use of the flow cytometry evaluation system 100 and with side access panel 210 in place in a closed position, such as illustrated in FIG. 2, to protect the flow cytometry investigation system 102 during use. The slidable shelf 244 may be locked in place in the first position, for example by a latch or thumb screw. The slidable shelf 244 may also be locked in place in the second position, for example by a different latch or thumb screw. The second position provides enhanced access to components of the flow cytometry investigation system 102 for maintenance and service.

The location, mounting and structure of the flow cytometry investigation system 102 in the lower compartment 206 on the slidable shelf 244 provides a number of operational advantages. As noted, mounting of componentry of the flow cytometry investigation system 102 on the slidable shelf 244 provides convenient access for maintenance and service. From a usability standpoint, locating the autosampler 140 in the upper compartment 204 provides advantages to a user accessing and observing operation of the autosampler 140 during normal operation. Mounting the flow cytometry investigation system 102 on the slidable shelf 244 in the lower compartment 206, in combination with locating the autosampler 140 in the upper compartment 204, provides an advantageous combination of enhanced utility of the flow cytometry evaluation system 100 by the user and enhanced access for maintenance and service of the flow cytometry investigation system 102.

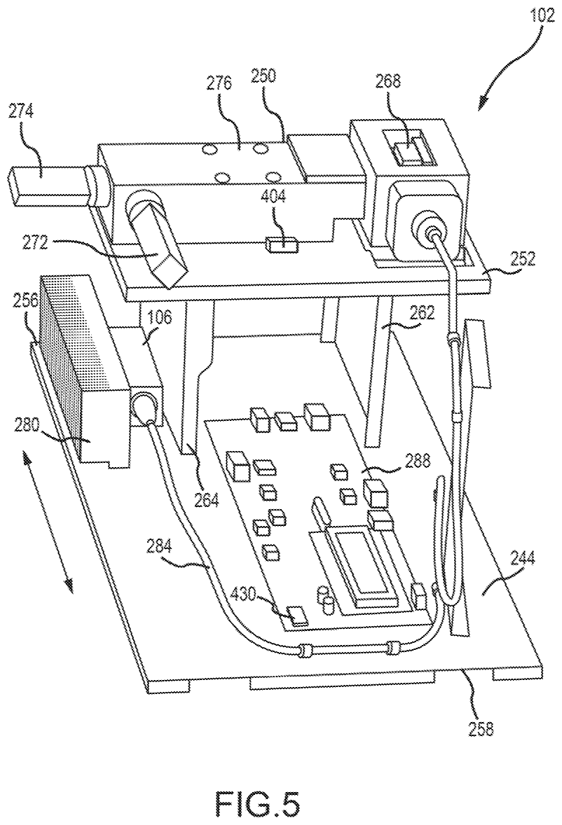

With reference primarily to FIGS. 3, 5 and 6, the flow cytometry investigation system 102 includes an optical processing system 250 mounted on a common optical component mounting member in the form of a common optical component mounting platform 252. In FIG. 3, the componentry the common optical component mounting platform 252 and much of the componentry of the optical processing system 250 are not visible as blocked from view by a protective cover 253. However, FIG. 5 illustrates the optical processing system 250 and the common optical component mounting platform 252 with the protective cover 253 removed. The slidable shelf 244 includes a front edge 256 disposed toward the side access panel 210 when the slidable shelf 244 is in the first position and a back edge 258 that is opposite the front edge 256 and is disposed away from the side access panel 210 when the slidable shelf 244 is in the second position. The common optical component mounting platform 252 is disposed toward the front edge 256 supported at an elevated position above the slidable shelf 244 by two support members 262 and 264. Also mounted on the slidable shelf 244 is a circuit board 288 with electronics for operation of various components of the flow cytometry investigation system 102. For clarity of illustrating various features of the flow cytometry investigation system 102, electrical connections between components of the flow cytometry investigation system 102 and the circuit board 288 are not illustrated in the figures.

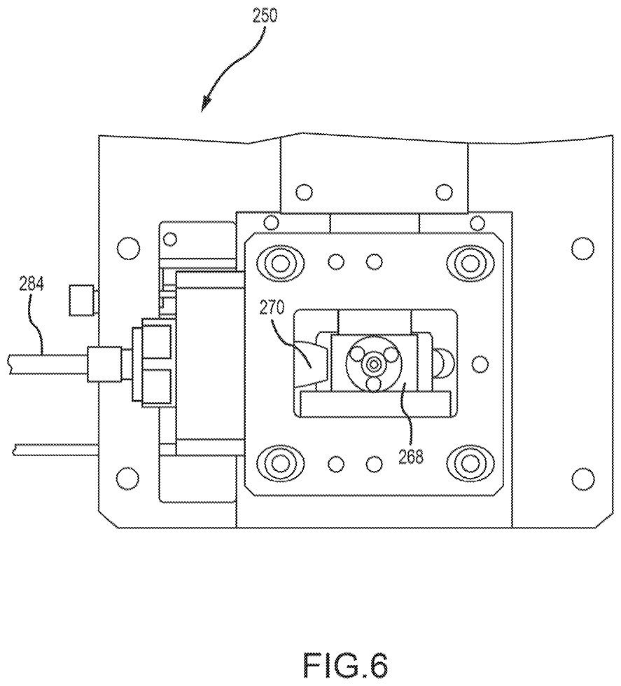

As illustrated in FIGS. 5 and 6, the optical processing system 250 supported on the common support platform 252 includes a flow cell 268, including the investigation zone 104 through which a fluid sample surrounded by sheath liquid flows for flow cytometry investigation. Input light 108 from the radiation delivery system 106 is delivered to the investigation zone 104 of the flow cell 268 as focused light from a light focusing element 270, to impinge the focused light on flow of the fluid sample in the flow cell 268. The input light 108 is transmitted to the light focusing element 270 through an optical conduction path including an optical conduit 284 between the radiation delivery system 106 and the light focusing element 270. In the example configuration illustrated in FIGS. 2-6, the radiation source 106 is in the form of a laser and the optical conduit 284 includes an optical fiber. The light focusing element 270) may be or include, for example, an optical component or combination of optical components (e.g., focusing lens, focusing mirror, tapering light guide) that focuses the input light 108 to an extent desired for delivery to the flow cell 268. In the optical processing system 250) there is a light collection lens that focuses emitted light to the light detectors. As an example, the optical processing system 250 includes two light detectors 272 and 274, illustrated for example as photomultiplier tubes, and a response radiation conduction path from the flow cell 268 to the light detectors 272 and 274. The response radiation conduction path is disposed in an enclosure 276 and includes a spatial filter (not shown), followed by a dichroic mirror (not shown) that separates response radiation by wavelength for delivery to either the first light detector 272 or the second light detector 274. The light detectors 272 and 274 may be preceded by optical filters to pass wavelengths of light desired to be detected by each of the light detectors 272 and 274. For example the light detectors 272 and 274 may be preceded by different optical filters to pass for detection different wavelengths of light to each of light detector 272 and 274 corresponding to different fluorescent emission signatures from different fluorescent stains to be detected.

The laser of the radiation delivery system 106 is a major heat-generating element of the flow cytometry investigation system 102 componentry disposed in the lower compartment 206, and the laser is thermally coupled to a heat sink 280 with cooling fins to dissipate heat generated by the light source. Heat removal may be aided by an exhaust fan (not shown) mounted on a back panel of the housing 202 of the instrument module 200 to evacuate warm air from the second compartment 206 and pull in cooler ambient air. Preferably such an exhaust fan is located on a back panel adjacent the heat sink 280. The performance of the optical processing system 250 mounted on the common optical component mounting platform 252 is susceptible to changes in component spacing and alignment with changes in temperature as a consequence of expansion and contraction of materials, and especially expansion and contraction of the common optical component mounting platform 252 on which the components of the optical processing system 250 are mounted. The common optical component mounting platform 252 may be made of any desired rigid material, with metallic materials (e.g., steel, aluminum) being preferred. Changes resulting from thermal expansion and contraction of the common optical component mounting platform 252 may often not be a significant issue for flow cytometry systems designed primarily to evaluate fluid samples for the presence of larger particles of a size on the order of cells, but even relatively small changes may have a greater impact when evaluating for very small particles such as virus-size particles, as a consequence for example of the generally weaker optical signals generated by the smaller particles. To counteract potential for detrimental performance effects from changes in temperature, the flow cytometry investigation system 102 includes advantageous design features, in addition to the noted exhaust fan.

One advantageous design feature is to provide for some thermal isolation between the light source 278 and the optical components of the optical processing system 250. In that regard, the light source 278 is not mounted on the common optical component mounting platform 252. In the example illustrated in FIGS. 2-6, the laser of the radiation delivery system 106 is mounted to the heat sink 280, which is mounted on the slidable shelf 244, to reduce direct conductive heating of the common support platform 252 and to provide a large exposed area for air flow around the laser and the heat sink 280 to remove heat being generated by the laser for efficient evacuation from the second compartment 206 by the noted exhaust fan.

Another advantageous design feature is to provide input light 108 from the light source to the flow cell 104 through an input light conduction path between the light source 278 and the light focusing element 270 utilizing an optical fiber, which is enclosed inside a protective optical conduit 284. The optical fiber in the optical conduit 284 has a first end adjacent to and optically coupled with the light source 278 to receive input light 108 from the light source 278 and a second end adjacent to and optically coupled with the light focusing element 270. The use of an optical fiber to conduct input light 108 from the light source 278 to the light focusing element 270) permits the input light conduction path to be essentially insensitive to changes in temperature, and additionally simplifies optics alignment issues otherwise presented by optical input conduction paths that utilize one or more mirrors to direct light to a flow cell, as is common in some flow cytometers.

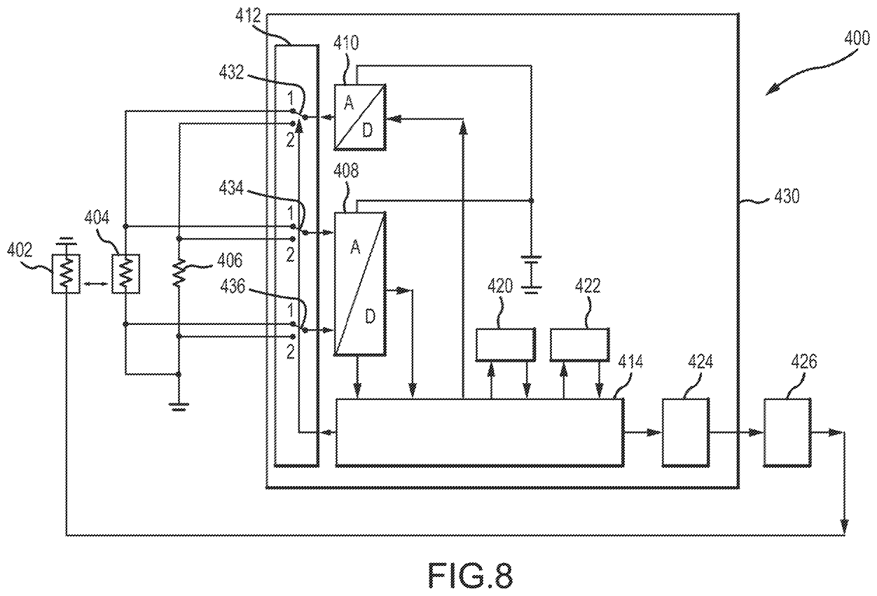

A further advantageous design feature is to provide for temperature control of the temperature of the common optical component mounting platform 252 through the use of a temperature control system with reduced self-heating that facilitates effective temperature control of the common optical component mounting platform. The temperature control system is discussed separately below with reference to FIGS. 8-10.

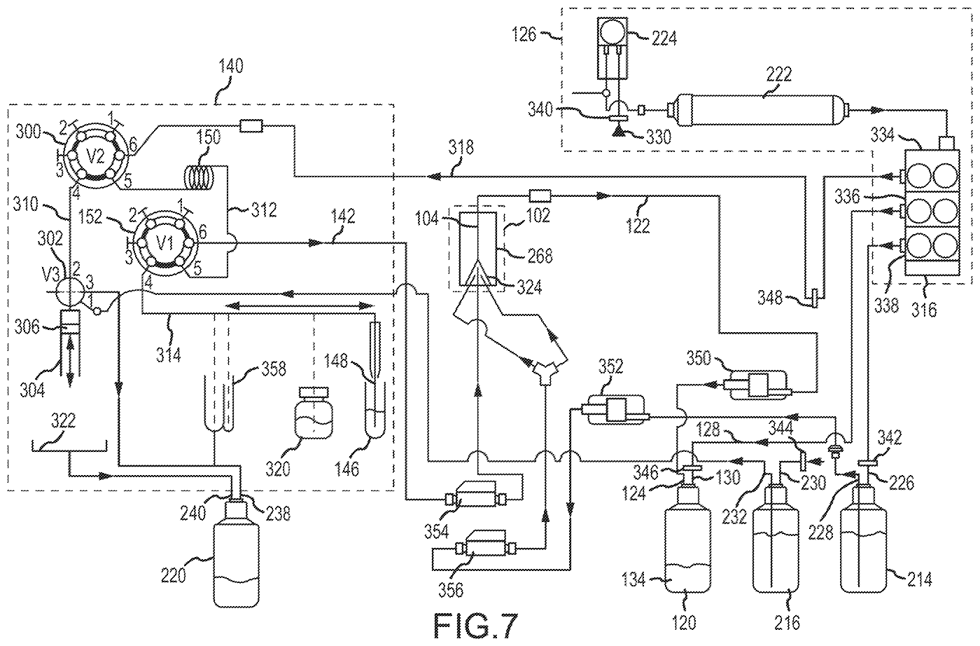

Reference is now made to FIG. 7, with includes a fluidics diagram of an example fluid system configuration of the instrument module 200. The fluidics diagram of FIG. 7 may also be referred to as a system plumbing diagram or a fluid flow diagram. FIG. 7 illustrates fluid flow and fluid handling features in the example of the flow cytometry system 100 included in the instrument module 200, including within the autosampler 140, the flow cytometry investigation system 102 and the pressurized gas delivery system 126. Only fluid features are illustrated in FIG. 7. Optical features are not illustrated.

With reference to FIG. 7, processing of a fluid sample for flow cytometry investigation begins with withdrawal of a fluid sample by the sample delivery probe 148 from one of the plurality of fluid containers 146. As illustrated in FIG. 7, the autosampler 140 includes three multi-component valves 152, 300 and 302, also designated in FIG. 7 as V1, V2 and V3 respectively. To withdraw a fluid sample from the fluid container 146, the valve 152 is set with position 4 connected to position 5, the valve 300 is set with position 4 connected to position 5 and the valve 302 is set with position 2 connected to a syringe 304. With valves 152, 300 and 302 set as noted, a plunger 306 of the syringe 304 is retracted to apply fluid suction through valve 302, valve 300 and valve 152 to the sample delivery probe 148 to draw fluid sample from the sample container 146. The plunger 306 is retracted sufficiently to draw a desired volume of the fluid sample for flow cytometry investigation into the sample holding zone 150, which is in the form of a coil of tubing as illustrated in FIG. 7. After a desired volume of fluid sample has been drawn into the sample holding zone 150, then retraction of the plunger 306 stops. Prior to commencement of retraction of the plunger 306 to draw fluid sample into the sample delivery probe 148 for delivery to the sample holding zone 150, the fluid path from the syringe 304 through the valve 302, fluid line 310, valve 300, fluid line 312 (including the sample holding zone 150), fluid line 314 and sample delivery probe 148 is filled with drive liquid previously supplied from the second container 216. After stopping retraction of the plunger 306, the fluid line 312 will be filled with fluid sample from valve 152 through a portion of the tubing coil of the sample holding zone 150 and will be filled with drive liquid in the remaining portion of the fluid line 312 to the valve 300. After the desired volume of the fluid sample has been pulled into the sample holding zone 150 and retraction of the plunger 306 has stopped, then positioning on valves 300 and 152 is changed to have only positions 5 and 6 open on each of those valves, and pressurized gas from the pressurized gas delivery system 126 is supplied at a regulated pressure from a gas pressure regulator 316 through fluid the line 318 and through open valve positions 6 and 5 of valve 300 to push the drive liquid and the fluid sample in front of the drive liquid, through open positions 5 and 6 of the valve 152 and through the fluid sample conduction path 142 to and through the investigation zone 104 in the flow cell 268 for flow cytometry investigation and then through the effluent fluid conduction path 122 to the effluent fluid inlet 124 for collection as part of the waste liquid 134 in the effluent collection vessel 120. Pushing the drive liquid to push the fluid sample out of the sample holding zone 150 and through the investigation zone 104 and to the effluent collection vessel 120 requires applying sufficient gas pressure behind the drive liquid to overcome effects of the positive back pressure in the fluidics system from the applied gas pressure to the effluent collection vessel 120 through the pressurized gas supply line 128.

Following a flow cytometry investigation on a fluid sample, fluid components of the autosampler 140 are subjected to a rinse cycle using rinse reagent from a reagent container 320, following which the fluid path from the syringe 304 through the valve 302, valve 300, sample holding zone 150, valve 152, fluid line 314 and the sample delivery probe 148 is filled with drive liquid from the second container 216, ready for withdrawing the next fluid sample from another one of the plurality of fluid containers 146 through the sample delivery probe 148 for the next flow cytometry investigation. Specifics of the rinse cycle are not described herein. Following the rinse cycle, the plunger 306 of the syringe is retracted from an advanced position with position 1 open on valve 302 to suction drive liquid from the second container 216 through the fluid line 322 into the syringe 304, following which position I on valve 302 is closed and position 2 on valve 302 is opened, and with positions 4 and 5 open on each of valves 300 and 152 the plunger 306 is then advanced to push the drive liquid through the fluid path to the tip of the sample delivery probe 148 with the sample delivery probe positioned to eliminate any excess drive liquid into a rinse station 358 for conduction through the waste inlet line 238 to be collected in the fourth container 220. As illustrated in FIG. 7, a drip pan 322 is positioned to catch any liquid leaks from the autosampler 140 for conduction to the fourth container 220 through the waste inlet line 240.

As illustrated in FIG. 7, the example configuration of the flow cytometry evaluation system 100 of the instrument module 200 includes a sheath liquid to surround the fluid sample for flow cytometry investigation in the investigation zone 104 in the flow cell 268. As illustrated in FIG. 7, during a flow cytometry investigation 104 of a fluid sample, sheath liquid is delivered from the first container 214 to a focusing zone 324 of the flow cell 268 where the sheath liquid is introduced around the flowing fluid sample and hydrodynamically focuses the flowing fluid sample for flow cytometry investigation in the investigation zone 104. Effluent of the sheath liquid exits the investigation zone 104 with effluent of the fluid sample and is collected as waste in the effluent collection container 120 along with effluent of the fluid sample.

Some other components are also illustrated in FIG. 7. An air inlet 330 provides for air intake to the compressor 224. A gas pressure regulator 316 includes pressure control valves 334, 336 and 338 to regulate the pressure at which pressurized gas is delivered to different portions of the system. Filters 340, 342, 344, 346 and 348 are placed on various gas lines to filter various gas streams. Shutoff valves 350 and 352 permit selective isolation of the effluent collection vessel 120 and first container 214 from the rest of the system. A sample flow sensor 354 measures flow of a fluid sample and sheath flow sensor 356 measures flow of sheath liquid to the flow cell 268 for a flow cytometry investigation. The sample delivery probe 148 is movable between the sample container 146, reagent bottle 320 and positions at a rinse station 358 to perform different operations through the sample delivery probe 148.

Reference is now made to FIG. 8 which illustrates an example temperature control system 400 disposed in the housing 202 in the lower compartment 206 of the instrument module 200, and preferably with all components of the temperature control system 400 supported on the slidable shelf 244. As shown in FIG. 8, the example temperature control system 400 includes an electrical heating unit 402 that is selectively operable to heat an environment within the lower compartment 206, and preferably the electrical heating unit 402 is positioned to apply heat directly by conduction to the common optical component mounting platform 252 to maintain the common optical component mounting platform 252 at a temperature in the vicinity of a target setpoint temperature. In that regard, the electrical heating unit 402 may be mounted on or may be embedded in or form a part of the common optical component mounting platform 252. As illustrated in FIG. 8, the electrical heating unit 402 includes a resistive heating element. The temperature control system 400 includes a temperature sensor 404, preferably including a thermistor, to provide a temperature sensor reading corresponding to a temperature condition in the lower compartment 206 of the housing 202. Preferably, the temperature sensor 404 is disposed to sense directly a temperature of the common optical component mounting platform 252. In that regard, the temperature sensor 404 may be mounted on or may be embedded in or form a part of the common optical component mounting platform 252. The temperature control system 400 includes a reference resistor 406 to provide a reference reading for use in combination with a corresponding temperature sensor reading to make a temperature determination. An analog-to-digital converter 408 is selectively connectable alternatively to the temperature sensor 404 to receive a temperature sensor reading or to the reference resistor 406 to receive a reference reading, and in either case to provide a digital output corresponding to the respective reading. A current source 410 is configured to provide AC electrical current alternatively to the temperature sensor 404 to take a sensor reading or to the reference resistor 406 to take a reference reading. A switch unit 412, for example in the form of a multiplexer, is operable to selectively switch direction of the electrical current from the current source 410 to the temperature sensor 404 or the reference resistor 406 and to selectively switch input to the analog-to-digital converter 408 to receive a temperature sensor reading or a reference reading. The switch unit 412 may include any desired number of switches. In the illustration of FIG. 8, the switch unit 412 as three switches 432, 434 and 436, each switchable between a first position (position 1) and a second position (position 2). A controller unit 414 is configured to control operations of the temperature control system 400, including periodically collecting temperature determination data sets with each data set including a first digital output from the analog-to-digital converter 408 corresponding to a sensor reading and a second digital output from the analog-to-digital converter 408 corresponding to a reference reading, periodically making temperature determinations based at least in part on such a temperature determination data set and directing as needed operation of the electrical heating unit to provide heat to warm the controlled environment (e.g., the common optical component mounting platform 252) toward a setpoint temperature, and to maintain the temperature of the controlled environment in the vicinity of the setpoint temperature. As illustrated in FIG. 8, the current source 410 is provided by a digital-to-analog converter that provides AC current from a DC power source as directed by the controller unit 414.

The temperature control system 400 also includes a first timer 420 and a second timer 422 that trigger, respectively, first and second interrupt service routines that provide chopper-stabilized operation. The temperature control system 400 also includes a pulse width modulation (PWM) unit 424 that receives temperature control instructions from the controller unit 414 based on temperature determinations and the PWM unit 424 outputs heater drive instructions to a driver unit 424 to operate the electrical heating unit at a level and for a duration to heat the controlled environment toward maintenance of the setpoint temperature, which is preferably a fixed setpoint temperature. The driver unit 426 may be or include a power source that is switchable between on and off modes to provide or not provide power to the electrical heating unit 402 to heat or not heat the controlled environment at the direction of the controller unit 414 according to instructions from the PWM unit 424. The driver unit 426 may have variable power output to provide different levels of power to operate the electrical heating unit 402 to heat the controlled environment at different rates, or the driver 426 may have a fixed power output to operate the electrical heating unit 402 at a fixed rate for the period of time that power is supplied to the electrical heating unit 402 from the driver unit 426.

A significant problem with close-tolerance temperature control of an environment in an enclosed space is potential for errors that can result from effects of local temperature changes and from self-heating of a temperature sensor from heat generated by operation of the temperature sensor. Existing techniques for temperature measurement include absolute measurement and ratiometric measurement techniques. Absolute temperature measurements are simple, but have problems with measurement error introduced through changes in supply voltage of a temperature sensor and/or reference voltage and self-heating of the temperature sensor through current applied for operation of a temperature sensor, which is typically continuously supplied to a temperature sensor. Ratiometric temperature measurements remove voltage variations as measurement errors but also have problems with offset, noise and drift vs. temperature, as well as self-heating of the temperature sensor. An important aspect of the temperature control system 400 of FIG. 8 is the chopper-stabilized operation including the interrupt service routines triggered by the first timer 420 and the second timer 422 associated with the periodic collection of temperature determination data sets for use by the controller unit 414 to periodically make temperature determinations and provide temperature control instructions as needed. The chopper-stabilized operation significantly reduces temperature sensor self-heating while taking temperature sensor readings at a desired sampling interval and while operating semiconductor electronics at a high frequency to reduce so-called 1/f semiconductor noise. In that regard, power-related noise of semiconductor features is often proportional to the inverse of power frequency (1/f) in lower frequency ranges (for example frequencies below about 10 to 100 Hz) and transitions to be almost independent of frequency at higher frequency ranges (for example frequencies above about 100 Hz. In preferred operation power from the current source 410 and operation of the analog-to-digital converter 408 are in such upper frequency ranges.

Advantageously, as illustrated in FIG. 8, the features of the analog-to-digital converter 408, current source 410, switch unit 412, controller unit 414, first timer 420, second timer 422 and PWM unit 424 may all be included on a single microchip 430, facilitating simplified circuit board design for the instrument module 200 and significantly reducing footprint and cost of electronics componentry. The driver unit 426 and reference resistor 406 may conveniently be mounted as electronic components on the circuit board 288 a common circuit board with the microchip. FIG. 5 shows an example location of the temperature sensor 404 and the microchip 430 on the circuit board 288. The reference resistor 406 and the driver unit 426 may also be components mounted on the circuit board 288.

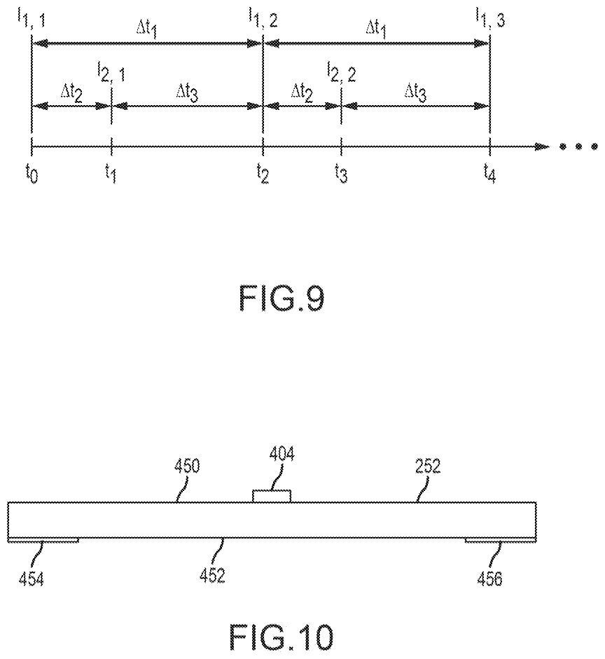

With reference to FIG. 8 and FIG. 9, an example procedure for collecting a temperature determination data set with the temperature control system 400 at the direction of the controller unit 414 is described during a timeline illustrated in FIG. 9. FIG. 9 shows a timeline for collecting a temperature determination data set including a first digital output from the analog-to-digital converter 408 corresponding to a temperature sensor reading and a second digital output from the analog-to-digital converter 408 corresponding to a reference reading. Time zero (t₀) corresponds with an interrupt of the first timer 420 (I_{1,1}) to start a first interrupt service routine triggered by the first timer 420. The first interrupt service routine starting at t₀ includes: restarting first timer 420 to run for a first time duration (Δt₁) of the first timer 420, setting each of the switches 332, 334 and 336 of the switch unit 412 to position 1, according to the value of a loop counter for the switch unit 412, to direct current from the current source 410 to the temperature sensor 404 and starting the second timer 422 to run for the second time duration (Δt₂) of the second timer 422. After expiration of the second time duration (Δt₂) at t₁, an interrupt of the second timer 422 (I_{2,1}) occurs commencing a second interrupt service routine triggered by the second timer 422. The second interrupt service routine starting at t₁ includes turning off the second timer 422 and starting the analog-to-digital converter 408. During the following third time duration (Δt3), when a digital output result is available from the analog-to-digital converter, then an interrupt is triggered and a first digital output corresponding to the temperature sensor reading is acquired and saved by the controller unit 414, and the analog-to-digital converter 408 is turned off and a loop counter (addressing the measuring point as being the temperature sensor 404 or the reference resistor 406) is incremented. As illustrated in FIG. 8, the temperature sensor reading comprises voltage drop across the temperature sensor 404, which is input to the analog-to-digital converter 408. At the expiration of the first time duration (Δt₁) at t₂, an interrupt of the first timer 420 (I_{1,2}) occurs to start a next first interrupt service routine triggered by the first timer 420. The first interrupt service routine starting at t₂ includes: restarting the first timer 420 to run for the first time duration (Δt₁) of the first timer 420, setting each of the switches 432, 434 and 436 of the switch unit 412 to position 2, according to the value of the loop counter for the switch unit 412, to direct current from the current source 410 to the reference resistor 406 and starting the second timer 422 to run for the second time duration (Δt₂) of the second timer 422. After expiration of the second time duration (Δt₂) at t₃, an interrupt of the second timer (I_{2,2}) occurs commencing a second interrupt service routine triggered by the second timer 422. The second interrupt service routine starting at t₃ includes turning off the second timer 422 and starting the analog-to-digital converter 408. During the following third time duration (Δt3), when a digital output result is available from the analog-to-digital converter then an interrupt is triggered and a second digital output corresponding to the reference reading is acquired and saved by the controller unit 414, and the analog-to-digital converter 408 is turned off and the corresponding loop counter is incremented. As illustrated in FIG. 8, the reference reading is a voltage drop across the reference resistor 406, which is input to the analog-to-digital converter 408. At the expiration of the first time duration (Δt₁) at t₄, an interrupt of the first timer 420 (I_{1,3}) occurs to start a next first interrupt service routine for acquiring a next temperature determination data set in the same manner. As can be appreciated, a temperature determination data set could alternatively include a digital output pair with a second digital output corresponding to a reference reading that was acquired prior to a first digital output corresponding to a temperature sensor reading.

After collecting a temperature determination data set, the controller unit 414 may perform a temperature determination, which may be performed each time a temperature determination data set is collected or only after a certain number of temperature determination data sets have been collected since a prior temperature determination. The temperature determination data set includes first data provided by the first digital output that corresponds to a temperature sensor reading in terms of voltage drop across the temperature sensor (Vsensor) and second data provided by the second digital output that corresponds to a reference reading in terms of voltage drop across the reference resistor (Vref). Temperature determinations may be made using the following relationships for Vsensor and Vref:

$$Vsensor = Isensor \times Rsensor ; and \\ Vref = Iref \times Rref$$

where Isensor is the current through the temperature sensor 404 corresponding to the temperature sensor reading, Rsensor is the resistance of the temperature sensor 404 corresponding to the temperature sensor reading, Iref is the current through the reference resistor 406 corresponding to the reference reading and Rref is the resistance of the reference resistor 406 corresponding to the reference reading. Because the current supplied from the current source 410 is essentially constant, Isensor will be essentially equal to Iref, and because the value of Rref is known for the reference resistor 406, the unknown variable Rsensor may be calculated as follows:

$$Rsensor = ( Vsensor / Vref ) \times Rref$$

The calculated Rsensor value can then be compared to a correlation table by the controller unit 414 of temperature vs. Rsensor for the temperature sensor 404 to determine a temperature corresponding to the temperature sensor reading, for use by the controller unit 414 to compare to the setpoint temperature to determine whether or not and by how much the electrical heating unit 202 should be operated to maintain the temperature of the controlled environment (e.g., temperature of the common optical component mounting platform 252) in the vicinity of the setpoint temperature. The correlation table may, for example, be saved in non-transitory memory of the controller unit 414 accessible by a computer processor of the controller unit 414. The controller unit 414 may also analyze a trend of multiple temperature determinations in determining whether or not and by how much the electrical heating unit 402 should be operated. As will be appreciated, it is important to select a setpoint temperature that will be higher than an ambient air temperature expected in the lower compartment 206 during operation of the flow cytometry investigation system 102 of the instrument module 200.

The second time duration (Δt₂) should be selected to be long enough to permit signal settling following switching of current to the temperature sensor 404 or the reference sensor 406. The first time duration (Δt₁) should extend for a time equal to at least the second time duration (Δt₂) plus an adequate time thereafter to obtain a digital output from the analog-to-digital converter 408 based on cycle time of the analog-to-digital converter 408.

A significant advantage of the chopper-stabilized operation of the temperature control system 400 to collect temperature determination data sets is that electrical current is not continuously supplied to the temperature sensor 404, which significantly reduces potential for detrimental self-heating of the temperature sensor that can lead to significant temperature sensor reading errors, while at the same time power the current source 410 and the analog-to digital converter 408 may be operated at high frequencies outside of the 1/f noise region.

One example set of operating variables for the temperature control unit 400 provides the second time duration of the second timer 422 at 1 millisecond and the frequency of conversion of the analog-to-digital converter at 600 Hz (cycle time 1.66 milliseconds). The first time duration of the first timer 420 would then at least 2.66 milliseconds (1 millisecond+1.66 milliseconds), and preferably somewhat longer to ensure acquisition of a digital conversion from the analog-to-digital converter 408.

Reference is now made to FIG. 10 illustrating one preferred configuration for positioning of the temperature sensor 404 and resistive heating elements of the electrical heating unit 402 relative to the common optical component mounting platform 252 on with the components of the optical processing system 250 are mounted. FIG. 10 shows the common optical component mounting platform 252 having a mounding side 450 on which components of the optical processing system are to be mounted and an opposite side 452. The temperature sensor 404 is mounted on the mounting side 450 and two resistive heating elements 454 and 456 (e.g., printed or adhered films of resistive heating material) are disposed adjacent to the opposite side 452. Also, the temperature sensor 404 is located near a longitudinal middle of the common optical component mounting platform 252, whereas the resistive heating elements 454 and 456 are disposed toward longitudinal ends of the common optical component mounting platform 252, to provide some separation distance of the thermal couple through the common optical component mounting platform 252 between the temperature sensor 404 and the resistive heating layers 454 and 456. The resistive heating elements 454 and 456 are illustrated as projecting from adjacent portions of the opposite side 452 of the common optical component mounting platform 252, but in an alternative configuration the common optical component mounting platform 252 may have recesses on the opposite side 452 in which the resistive heating layers could be disposed.

### Example Implementation Combinations

Some other contemplated embodiments of implementation combinations for various aspects of this disclosure, with or without additional features as disclosed above or elsewhere herein, are summarized as follows:
1. A flow cytometry evaluation system, comprising:
a flow cytometry investigation system comprising an investigation zone configured to receive during a flow cytometry evaluation a flow of a fluid sample for flow cytometry investigation in the investigation zone for the presence of particles in the flow of the fluid sample:
a sample effluent system, comprising:
   an effluent collection vessel with an effluent fluid inlet to receive in the effluent collection vessel an effluent of the fluid sample exiting the investigation zone during a flow cytometry evaluation; and
   an effluent fluid conduction path from the investigation zone to the effluent fluid inlet; and
a pressurized gas delivery system in fluid communication with the sample effluent system, wherein the pressurized gas delivery system is configured to apply pressurized gas to pressurize at least a portion of the fluid sample effluent system at an applied gas pressure that provides a positive back pressure in the effluent fluid conduction path impeding fluid flow through the effluent fluid conduction path toward the effluent fluid inlet during a flow cytometry investigation.
2. The flow cytometry evaluation system of paragraph 1, wherein the pressurized gas is applied to the sample effluent system at an elevation in the sample effluent system that is lower than a lowest elevation in the investigation zone.
3. The flow cytometry evaluation system of paragraph 2, wherein the applied gas pressure is at a gauge pressure at least as large as, preferably larger than, more preferably at least 0.1 psi (0.69 kPa) larger than, and even more preferably at least 0.2 psi (1.38 kPa) larger than, a head pressure of a water column of a vertical height equal to a difference in elevation between the elevation of the where the pressurized gas is applied to the sample effluent system and the lowest elevation of the investigation zone.
4. The flow cytometry evaluation system of either one of paragraph 2 or paragraph 3, wherein an elevation difference between the lowest elevation of the investigation zone and the elevation in the sample effluent system where the pressurized gas is applied is at least 15 centimeters and preferably at least 30 centimeters, and optionally is not more than 120 centimeters or preferably not more than 80 centimeters.
5. The flow cytometry evaluation system of any one of paragraphs 1-4, wherein the pressurized gas is applied to the effluent collection vessel.
6. The flow cytometry evaluation system of paragraph 5, wherein the effluent fluid inlet is at an lower elevation than a lowest elevation of the investigation zone, and the applied gas pressure in the effluent collection vessel is at a gauge pressure at least as large as, preferably larger, more preferably at least 0.1 psi (0.69 kPa) larger than and even more preferably at least 0.2 psi (1.38 kPa) larger than, a head pressure of a water column of a vertical height equal to a difference in elevation between the elevation of the effluent liquid inlet and the lowest elevation of the investigation zone. Optionally, the gauge pressure of the applied gas pressure is not greater than 1.0 psi (6.89 kPa) larger than a head pressure of a water column of a vertical height equal to a difference in elevation between the elevation of the effluent liquid inlet and the lowest elevation of the investigation zone.
7. The flow cytometry evaluation system of paragraph 6, wherein an elevation difference between the lowest elevation of the investigation zone and the elevation of the effluent liquid inlet is at least 15 centimeters and preferably at least 30 centimeters, and optionally is not more than 120 centimeters or preferably not more than 80 centimeters.
8. The flow cytometry evaluation system of any one of paragraphs 1-7, comprising a fluid sample conduction path to the investigation zone to provide the fluid sample to the investigation zone for the flow cytometry investigation.
9. The flow cytometry evaluation system of paragraph 8, wherein the fluid sample conduction path, the investigation zone, the effluent fluid conduction path and the effluent collection vessel are configured to comprise a pressurized fluidics system during a flow cytometry investigation with fluid flow through the fluidics system in a direction toward the effluent collection vessel impeded by the back pressure from the applied gas pressure.
10. The flow cytometry evaluation system of paragraph 9, wherein a highest elevation in the fluidics system is in the fluid sample conduction path.
11. The flow cytometry evaluation system of any one of paragraphs 8-10, wherein:
a highest elevation in the fluid sample conduction path is higher than a highest elevation in the investigation zone and is higher than an elevation of the effluent fluid inlet.
12. The flow cytometry evaluation system of paragraph 11, wherein the applied gas pressure is applied to the effluent collection vessel at a gauge pressure at least as large as, preferably larger than and more preferably at least 0.1 psi (0.69 kPa) larger than and even more preferably at least 0.2 psi (1.38 kPa) larger than, a head pressure of a water column of a vertical height equal to a difference in elevation between the highest elevation in the fluid sample conduction path and the elevation of the effluent fluid inlet. Optionally, the gauge pressure of the applied gas pressure is not greater than 1.0 psi (6.89 kPa) larger than a head pressure of a water column of a vertical height equal to a difference in elevation between the highest elevation in the fluid sample conduction path and the elevation of the effluent fluid inlet.
13. The flow cytometry evaluation system of either one of paragraph 11 or paragraph 12, wherein an elevation difference between the highest elevation in the investigation zone and the highest elevation in the fluid sample conduction path is at least 15 centimeters and preferably at least 30 centimeters, and optionally is not larger than 120 centimeters or preferably not larger than 80 centimeters.
14. The flow cytometry evaluation system of any one of paragraphs 8-13, comprising an autosampler configured to receive a plurality of the fluid samples contained in a plurality of sample containers and to deliver the plurality of the fluid samples in a sequence to the fluid sample conduction path for sequential conduction to the investigation zone for sequential flow cytometry evaluation of the plurality of the fluid samples, and wherein:
the flow cytometry investigation system and the autosampler are in a stacked relationship with the autosampler disposed at a first stack location above a second stack location where the flow cytometry investigation system is disposed.
15. The flow cytometry evaluation system of paragraph 14, comprising a housing in which the flow cytometry investigation system and the autosampler are disposed, wherein the first stack location is in a first compartment within the housing and the second stack location is in a second compartment within the housing disposed below the first compartment.
16. The flow cytometry evaluation system of either one of paragraph 14 or paragraph 15, wherein:
the autosampler comprises a sample receiving location configured to receive a plurality of sample containers containing a plurality of the fluid samples for sequential flow cytometry evaluation; and
the autosampler comprises a sample delivery probe configured to withdraw the fluid samples from the sample containers for sequential delivery of the plurality of the fluid samples to the investigation zone for the sequential flow cytometry evaluation; and
the sample receiving location is disposed higher in elevation, preferably at least 15 centimeters higher in elevation and more preferably at least 30 30 centimeters higher in elevation, than a highest elevation in the investigation zone, and optionally is disposed not more than 120 centimeters or preferably not more than 80 centimeters higher in elevation than the highest elevation in the investigation zone.
17. The flow cytometry evaluation system of any one of paragraphs 14-16, comprising a waste container in fluid communication with the autosampler to receive waste liquid from the autosampler, wherein the waste container is not pressurized.
18. The flow cytometry evaluation system of any one of paragraphs 1-17, wherein the pressurized gas delivery system comprises a gas pressure regulator in fluid communication with the sample effluent system, the gas pressure regulator configured to receive pressurized gas input and provide regulated gas output to provide the applied gas pressure to the sample effluent system, and preferably to the effluent collection container.
19. The flow cytometry evaluation system of paragraph 18, wherein the pressurized gas delivery system comprises a gas compressor in fluid communication with the gas pressure regulator.
20. The flow cytometry evaluation system of any one of paragraphs 1-19, wherein the flow cytometry investigation system is part of a single-unit instrument module.
21. The flow cytometry evaluation system of paragraph 20, comprising the gas compressor of paragraph 19, and wherein the gas compressor is part of the instrument module.
22. The flow cytometry evaluation system of either one of paragraph 20 or paragraph 21, comprising the autosampler of any one of paragraphs 14-17, wherein the autosampler is part of the instrument module.
23. The flow cytometry evaluation system of paragraph 20, comprising the gas compressor of paragraph 19 and the autosampler of any one of paragraphs 14-17, wherein the autosampler and the gas compressor are part of the instrument module and are disposed within a common housing of the instrument module.
24. The flow cytometry evaluation system of any one of paragraphs 1-23, wherein the
   flow cytometry investigation system includes an optical processing system supported on a common optical component mounting member (optionally a platform), the optical processing system comprising a flow cell with the investigation zone, a light focusing element to focus input light prior to the investigation zone and a light detection system to detect response radiation from the investigation zone.
25. The flow cytometry evaluation system of paragraph 24, wherein the flow cytometry investigation system comprises a light source to provide the input light, and the light source is optically connected to the light focusing element by an inlet light conduction path comprising an optical fiber.
26. The flow cytometry evaluation system of paragraph 24, wherein the light source comprises a laser optically coupled with the optical fiber to provide the input light to the optical fiber for conduction through the input light conduction path to the light focusing element.
27. The flow cytometry evaluation system of either one of paragraph 25 or paragraph 26, wherein the light source is not part of the optical processing system supported on the common optical component mounting member.
28. The flow cytometry evaluation system of paragraph 27, wherein the optical fiber has a first end adjacent to the light source to receive input light from the light source and a second end supported on the common optical component mounting member to provide the input light to the light focusing element.
29. The flow cytometry evaluation system of any one of paragraphs 24-28, comprising a housing containing a housed interior space in which the flow cytometry investigation system is disposed during a flow cytometry evaluation; and
a translationally mounted member on which the flow cytometry investigation system is supported, the translationally mounted member being translatable between a first position with the flow cytometry investigation system disposed in a housed interior space and a second position with at least a portion, and preferably all, of the flow cytometry investigation system disposed outside the housed interior space to provide enhanced service access to the flow cytometry investigation system.
30. The flow cytometry evaluation system of paragraph 29, wherein the housing comprises an access member that is movable to open the housing to provide access to the translatable member to translate the member from the first position to the second position.
31. The flow cytometry evaluation system of paragraph 30, wherein when the access member is in a closed position the translatable member is fully contained in the housed interior space within the housing.
32. The flow cytometry evaluation system of either one of paragraph 30 or 31, wherein the access member comprises a removable access panel.
33. The flow cytometry evaluation system of any one of paragraphs 29-32, wherein the common optical component mounting member is spaced from the slidable member by at least one support member on which the common optical component mounting member is supported, and wherein the light source is mounted on a said support member.
34. The flow cytometry evaluation system of any one of paragraphs 24-33, comprising a temperature control system to control a temperature within a housing in which the optical processing system is disposed, the temperature control system comprising:
a controller unit configured to periodically collect a temperature determination data set comprising first and second digital outputs corresponding to a temperature sensor reading and a reference reading, respectively, wherein collection of a temperature determination data set comprises:
   first directing electrical current to acquire, after a first signal settling period following commencement of the first directing, a first said digital output corresponding to a said sensor reading; and
   after the acquiring the first said digital output, second directing electrical current to acquire, after a second signal settling period following commencement of the second directing, a second said digital output corresponding to a said reference reading:
      and optionally the temperature control system comprising:
an electrical heating unit disposed within the housing and selectively operable to heat an environment within the housing:
a temperature sensor disposed inside the housing and operable to provide a temperature sensor reading corresponding to a temperature condition:
a reference resistor disposed inside the housing operable to provide a reference reading:
an analog-to-digital converter selectively connectable to alternatively receive a said temperature sensor reading from the temperature sensor or a said reference reading from the reference resistor and to provide a corresponding digital output:
a current source to provide electrical current alternatively to the temperature sensor to generate a said temperature sensor reading or to the reference resistor to generate a said reference reading:
a switch unit to selectively switch direction of the electrical current to the temperature sensor or the reference resistor and to selectively switch input to the analog-to-digital converter to receive a said temperature sensor reading or a said reference reading:
a controller unit configured to control operations of the temperature control system, the operations comprising:
   periodically collecting a temperature determination data set comprising first and second said digital outputs from the analog-to-digital converter corresponding to a said sensor reading and a said reference reading:
   periodically making a temperature determination using a said temperature determination data set; and
   directing operation of the electrical heating unit based at least in part on a said temperature determination;
wherein, the collecting a temperature determination data set comprises:
   first directing the electrical current through the switch unit to the temperature sensor and a resulting sensor reading to the analog-to-digital converter:
   after a first signal settling period following commencement of the first directing, acquiring by the controller unit a first said digital output corresponding to a said sensor reading:
   after the acquiring the first said digital output, second directing the electrical current through the switch unit to the reference resistor and a resulting reference reading to the analog-to-digital converter; and
   after a second signal settling period following commencement of the second directing, acquiring by the controller unit a second said digital output corresponding to a said reference reading.
35. The flow cytometry evaluation system of paragraph 34, wherein the temperature control system comprises:
a first timer to time a first time duration between commencement of a said first directing and commencement of a said second directing for the collecting of a said temperature determination data set; and
a second timer to time a second time duration of the first signal settling period.
36. The flow cytometry evaluation system of paragraph 35, wherein the first signal settling period and the second signal settling period are each equal to the second time duration and are each timed by the second timer.
37. The flow cytometry evaluation system of either one of paragraph 35 or paragraph 36, wherein a time duration between commencement of the second directing for collection of the temperature determination data set and commencement of a next said first directing for collection of a next said temperature determination data set is equal to the first time duration and is timed by the first timer.
38. The flow cytometry evaluation system of any one of paragraphs 35-37, wherein the current source, the analog-to-digital converter, the controller unit, the first timer and the second timer are on a single microchip.
39. The flow cytometry evaluation system of paragraph 38, comprising a pulse width modulation unit on the microchip in communication with the controller unit to receive temperature control instructions from the controller unit and direct drive instructions to drive operation of the heating unit to heat the environment.
40. The flow cytometry evaluation system of any one of paragraphs 34-39, configured to perform the collecting a said temperature determination data set at a frequency in a range of from 10 times per second to 150 times per second.
41. The flow cytometry evaluation system of any one of paragraphs 34-40, wherein the temperature sensor is disposed to sense a temperature of the common optical component mounting member.
42. The flow cytometry evaluation system of any one of paragraphs 34-41, wherein the temperature sensor is disposed to sense a temperature of a mounting side of the common optical component mounting member on which the optical processing system is mounted.
43. The flow cytometry evaluation system of paragraph 42, wherein the electrical heating unit comprises an electrical heating element adjacent a surface of the common optical component mounting member on a side of the common optical component mounting member opposite the mounting side.
44. The flow cytometry evaluation system of any one of paragraphs 34-43, wherein the temperature sensor comprises a thermistor.
45. The flow cytometry evaluation system of any one of paragraphs 34-44, wherein the controller unit is configured to maintain a setpoint temperature in a range of from 25° C., to 45° C., and more preferably in a range of from 28° C., to 33° C.
46. The flow cytometry evaluation system of any one of paragraphs 1-45, comprising:
a receiving location to receive at least one fluid container in a received position to contain a fluid associated with operation of the flow cytometry evaluation system:
a light illumination system configured to illuminate an interior space within a said fluid container when in the receiving location in the received position.
47. The flow cytometry evaluation system of paragraph 46, wherein a said fluid container in the received position is observable from a font side of the said fluid container and the light illumination system comprises a lighting element, optionally comprising a LED, disposed to shine through a back side of the fluid container opposite the front side.
48. The flow cytometry evaluation system of either one of paragraph 46 or paragraph 47, wherein the receiving location is configured to receive a plurality of said fluid containers each in a separate said received position with a said interior space illuminated by the light illumination system.
49. The flow cytometry evaluation system of paragraph 48, wherein the light illumination system comprises a separate lighting element to illuminate each said fluid container of the plurality of fluid containers. 50. The flow cytometry evaluation system of any one of paragraphs 46-49, wherein the receiving location is disposed in a container compartment with an optically transparent housing portion through which each said fluid container in a said received position is observable when illuminated by the light illumination system.
51. The flow cytometry evaluation system of any one of paragraphs 46-50, wherein the light illumination system comprises at least one lighting element, optionally disposed within the container compartment of paragraph 50, and oriented to shine into a said interior space of a said fluid container when disposed in the receiving location in the received position.
52. The flow cytometry evaluation system of any one of paragraphs 46-51, comprising at least one said fluid container, and optionally a plurality of said fluid containers, disposed in the receiving location each in a said received position.
53. The flow cytometry evaluation system of paragraph 52, comprising the effluent collection vessel disposed in the receiving location in a said received position.
54. The flow cytometry evaluation system of either one of paragraph 52 or paragraph 53, comprising a sheath fluid container disposed in the receiving location in a said received position, the sheath fluid container containing sheath fluid for use in a said flow cytometry evaluation and being fluidly connected with the investigation zone.
55. The flow cytometry evaluation system of paragraph any one of paragraphs 52-54, comprising a drive liquid container disposed in the receiving location in a said received position, the drive liquid container containing drive liquid to push fluid samples to and through the investigation zone during a said flow cytometry evaluation, and being fluidly connected to a fluid sample conduction path to the investigation zone.
56. The flow cytometry evaluation system of any one of paragraphs 52-55, comprising:
an autosampler, optionally the autosampler of any one of paragraphs 14-17; and
a waste container disposed in the receiving location in a said received position to collect waste fluid from operation of the autosampler.
57. The flow cytometry evaluation system of any one of paragraphs 52-56, comprising the autosampler in a combination of any one of paragraphs 14-17, and wherein:
the said receiving location is located in front of the second compartment at a lower elevation than the first compartment.
58. A method for flow cytometry evaluation, the method comprising:
flowing a fluid sample through an investigation zone of a flow cytometry investigation system with a downstream end of the investigation zone being in fluid communication with a sample effluent system comprising:
   an effluent collection vessel with an effluent fluid inlet to receive in the effluent collection vessel an effluent of the fluid sample exiting the investigation zone during a flow cytometry evaluation; and
   an effluent fluid conduction path from the investigation zone to the effluent fluid inlet:
performing a flow cytometry investigation of a flow of the fluid sample in the investigation zone:
conducting an effluent of the fluid sample exiting the investigation zone through the effluent fluid conduction path to the effluent collection vessel where the effluent of the fluid sample is collected; and
during the flowing the fluid sample through the investigation zone, applying pressurized gas to pressurize at least a portion of the fluid sample effluent system at an applied gas pressure that provides a positive back pressure in the effluent fluid conduction path impeding fluid flow through the effluent fluid conduction path toward the effluent fluid inlet of the effluent collection vessel.
59. The method of paragraph 58, comprising providing the fluid sample to the investigation zone through a fluid sample conduction path, wherein during the flow cytometry investigation the fluid sample conduction path, the investigation zone, the effluent fluid conduction path and the effluent collection vessel comprise a pressurized fluidics system with fluid flow through the fluidics system in a direction toward the effluent collection vessel impeded by the back pressure from the applied gas pressure.
60. The method of paragraph 59, comprising sequential flow cytometry evaluation of a plurality of the fluid samples, the sequential flow cytometry evaluation comprising withdrawing the plurality of the fluid samples from a plurality of sample containers in a sequence by an autosampler and delivering the plurality of the fluid samples to the fluid sample conduction path in the sequence for sequential conduction to the investigation zone for performance of the flow cytometry investigation on each of the plurality of the fluid samples, and wherein:
during the withdrawing, the plurality of the sample containers are at a higher elevation than a highest elevation in the investigation zone.
61. The method of any one of paragraphs 58-60, wherein the flow cytometry investigation system comprises a light source to provide input light and an input light conduction path to conduct the input light from the light source to the investigation zone for the flow cytometry investigation.
62. The method of paragraph 61, wherein the input light conduction path comprises an optical fiber.
63. The method of any one of paragraphs 58-62, wherein the flow cytometry investigation system includes an optical processing system supported on a common optical component mounting member, the optical processing system comprising a flow cell with the investigation zone, an inlet light focusing element of the input light conduction path to focus the input light prior to the investigation zone and a light detection system to detect response radiation from the investigation zone.
64. The method of paragraph 63, comprising controlling a temperature of the common optical component mounting member with a temperature control system at the direction of a controller unit, wherein the controlling comprises periodically collecting by the controller unit a temperature determination data set comprising first and second said digital outputs corresponding to a temperature sensor reading and a reference reading, respectively, wherein the collecting a temperature determination data set comprises:
   first directing electrical current to acquire, after a first signal settling period following commencement of the first directing, a first said digital output corresponding to a said sensor reading; and
   after the acquiring the first said digital output, second directing electrical current to acquire, after a second settling period following the second commencement of the second directing, a second said digital output corresponding to a said reference reading:
      and optionally the temperature control system comprising:
an electrical heating unit disposed within a housing also containing the optical processing system, the electrical heating unit being selectively operable to heat an environment within the housing:
a temperature sensor disposed inside the housing and operable to provide a temperature sensor reading corresponding to a temperature condition:
a reference resistor disposed inside the housing operable to provide a reference reading:
an analog-to-digital converter selectively connectable to alternatively receive a temperature sensor reading from the temperature sensor or a reference reading from the reference resistor and to provide a corresponding digital output:
a current source to provide electrical current alternatively to the temperature sensor to take a temperature sensor reading or to the reference resistor to take a reference reading:
a switch unit to selectively switch direction of the electrical current to the temperature sensor or the reference resistor and to selectively switch input to the analog-to-digital converter to receive a temperature sensor reading or a reference resistor reading:
a controller unit configured to control operations of the temperature control system, the operations comprising:
   periodically collecting a temperature determination data set comprising first and second said digital outputs from the analog-to-digital converter corresponding to a sensor reading and a reference reading:
   periodically making a said temperature determination using a said data set; and
   directing operation of the electrical heating unit based at least in part on a said temperature determination:
wherein, the collecting a temperature determination data set comprises:
   first directing the electrical current through the switch unit to the temperature sensor and a resulting sensor reading to the analog-to-digital converter:
   after a first signal settling period following commencement of the first directing, acquiring by the controller unit a first said digital output corresponding to a said sensor reading:
   after the acquiring the first said digital output, second directing the electrical current through the switch unit to the reference resistor and a resulting reference reading to the analog-to-digital converter; and
   after a second settling period following the second commencement of the second directing, acquiring by the controller unit a second said digital output corresponding to a said reference reading.
65. The method of paragraph 64, comprising heating the common optical component mounting member through heat supplied by operation of the electrical heating unit at the direction of the controller unit.
66. The method of any one of paragraphs 58-65, wherein the method is performed in the flow cytometry evaluation system of any one of paragraphs 1-45.
67. The method of any one of paragraphs 58-66, comprising operation of a flow cytometry evaluation system as recited in any one of paragraphs 1-57.
68. Use of the flow cytometry evaluation system of any one of paragraphs 1-57 to perform a flow cytometry evaluation of a fluid sample, and optionally of each one of a plurality of fluid samples.

The foregoing description of the present invention and various aspects thereof has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain known modes of practicing the invention and to enable others skilled in the art to utilize the invention in such or other embodiments and with various modifications required by the particular application(s) or use(s) of the present invention. It is intended that the appended claims be construed to include alternative embodiments to the extent permitted by the prior art.

The description of a feature or features in a particular combination do not exclude the inclusion of an additional feature or features in a variation of the particular combination. Processing steps and sequencing are for illustration only, and such illustrations do not exclude inclusion of other steps or other sequencing of steps to an extent not necessarily incompatible. Additional steps may be included between any illustrated processing steps or before or after any illustrated processing step to an extent not necessarily incompatible.

The terms “comprising”, “containing”, “including” and “having”, and grammatical variations of those terms, are intended to be inclusive and nonlimiting in that the use of such terms indicates the presence of a stated condition or feature, but not to the exclusion of the presence also of any other condition or feature. The use of the terms “comprising”, “containing”, “including” and “having”, and grammatical variations of those terms in referring to the presence of one or more components, subcomponents or materials, also include and is intended to disclose the more specific embodiments in which the term “comprising”, “containing”, “including” or “having” (or the variation of such term) as the case may be, is replaced by any of the narrower terms “consisting essentially of” or “consisting of” or “consisting of only” (or any appropriate grammatical variation of such narrower terms). For example, a statement that something “comprises” a stated element or elements is also intended to include and disclose the more specific narrower embodiments of the thing “consisting essentially of” the stated element or elements, and the thing “consisting of” the stated element or elements. Examples of various features have been provided for purposes of illustration, and the terms “example”, “for example” and the like indicate illustrative examples that are not limiting and are not to be construed or interpreted as limiting a feature or features to any particular example. The term “at least” followed by a number (e.g., “at least one”) means that number or more than that number. The term at “at least a portion” means all or a portion that is less than all. The term “at least a part” means all or a part that is less than all.

What is claimed is:

1. A flow cytometry evaluation system, comprising:
a flow cytometry investigation system comprising an investigation zone configured to receive during a flow cytometry evaluation a flow of a fluid sample;
a sample effluent system, comprising:
an effluent collection vessel with an effluent fluid inlet to receive an effluent of the fluid sample exiting the investigation zone during a flow cytometry evaluation, and
an effluent fluid conduction path from the investigation zone to the effluent fluid inlet; and
a pressurized gas delivery system in fluid communication with the sample effluent system, wherein the pressurized gas delivery system is configured to apply pressurized gas to pressurize at least a portion of the fluid sample effluent system to impede fluid flow through the effluent fluid conduction path toward the effluent fluid inlet during a flow cytometry investigation.

2. The flow cytometry evaluation system of claim 1, wherein the pressurized gas is applied to the sample effluent system at an elevation in the sample effluent system that is lower than a lowest elevation in the investigation zone.

3. The flow cytometry evaluation system of either one of claim 1 or claim 2, wherein the pressurized gas is a positive back pressure applied to the effluent collection vessel.

4. The flow cytometry evaluation system of any one of claims 1-3, further comprising:
a fluid sample conduction path to the investigation zone to provide the fluid sample to the investigation zone for the flow cytometry investigation,
wherein the fluid sample conduction path, the investigation zone, the effluent fluid conduction path and the effluent collection vessel are configured to comprise a pressurized fluidics system during the flow cytometry investigation.

5. The flow cytometry evaluation system of claim 4, wherein a highest elevation in the fluidics system is in the fluid sample conduction path at a higher elevation than the effluent fluid inlet.

6. The flow cytometry evaluation system of claim 5, wherein the applied gas pressure is applied to the effluent collection vessel at a gauge pressure at least as large as a head pressure of a water column of a vertical height equal to a difference in elevation between the highest elevation in the fluid sample conduction path and the elevation of the effluent fluid inlet.

7. The flow cytometry evaluation system of any one of claims 4-6, further comprising:
an autosampler configured to receive a plurality of the fluid samples contained in a plurality of sample containers and to deliver the plurality of the fluid samples to the fluid sample conduction path for flow cytometry evaluation.

8. The flow cytometry evaluation system of claim 7, further comprising:
a housing in which the flow cytometry investigation system and the autosampler are disposed in a stacked relationship,
wherein the first stack location is in a first compartment within the housing with the autosampler disposed therein and the second stack location is in a second compartment within the housing with the flow cytometry investigation system disposed therein, and
wherein the second compartment is disposed below the first compartment.

9. The flow cytometry evaluation system of either one of claim 7 or claim 8, wherein:
the autosampler comprises a sample receiving location configured to receive a plurality of sample containers containing a plurality of the fluid samples for flow cytometry evaluation,
the autosampler comprises a sample delivery probe configured to withdraw the fluid samples from the sample containers for delivery to the investigation zone for flow cytometry evaluation, and
the sample receiving location is disposed higher in elevation than a highest elevation in the investigation zone.

10. The flow cytometry evaluation system of any one of claims 7-9, wherein the flow cytometry investigation system and the autosampler are part of a single-unit instrument module.

11. The flow cytometry evaluation system of any one of claims 1-10, wherein the pressurized gas delivery system comprises a gas pressure regulator in fluid communication with the sample effluent system, the gas pressure regulator configured to receive pressurized gas input and provide regulated gas output to provide the applied gas pressure to the sample effluent system.

12. The flow cytometry evaluation system of any one of claims 1-11, wherein the flow cytometry investigation system includes an optical processing system supported on an optical component mounting member, the optical processing system comprising a flow cell with the investigation zone, a light focusing element to focus input light prior to the investigation zone, and a light detection system to detect response radiation from the investigation zone.

13. The flow cytometry evaluation system of claim 12, wherein the flow cytometry investigation system comprises a light source to provide the input light, the light source being optically connected to the light focusing element by an inlet light conduction path comprising an optical fiber.

14. The flow cytometry evaluation system of either one of claim 12 or claim 13, further comprising:
an interior space in which the flow cytometry investigation system is disposed during flow cytometry evaluation; and
a translationally mounted member on which the flow cytometry investigation system is supported, the translationally mounted member being translatable between a first position with the flow cytometry investigation system disposed in the interior space and a second position with at least a portion of the flow cytometry investigation system disposed outside the interior space.

15. The flow cytometry evaluation system of any one of claims 12-14, further comprising:
a temperature control system to control a temperature within a housing in which the optical processing system is disposed, the temperature control system comprising:
a controller unit configured to periodically collect a temperature determination data set comprising first and second digital outputs corresponding to a temperature sensor reading and a reference reading, respectively, wherein collection of a temperature determination data set comprises:
first directing electrical current to acquire, after a first signal settling period following commencement of the first directing, a first said digital output corresponding to a said sensor reading, and
after the acquiring the first said digital output, second directing electrical current to acquire, after a second signal settling period following commencement of the second directing, a second said digital output corresponding to a said reference reading.

16. The flow cytometry evaluation system of claim 15, wherein the temperature control system comprises:
a first timer to time a first time duration between commencement of a said first directing and commencement of a said second directing for the collecting of a said temperature determination data set, and
a second timer to time a second time duration of the first signal settling period.

17. The flow cytometry evaluation system of claim 16, further comprising:
a current source, an analog-to-digital converter, the controller unit, the first timer and the second timer on a single microchip.

18. The flow cytometry evaluation system of claim 17, further comprising:
a pulse width modulation unit on the microchip in communication with the controller unit to receive temperature control instructions from the controller unit and direct drive instructions to drive operation of a heating unit to heat an environment within the housing.

19. The flow cytometry evaluation system of any one of claims 1-18, further comprising:
a receiving location to receive at least one fluid container in a received position to contain a fluid associated with operation of the flow cytometry evaluation system; and
a light illumination system configured to illuminate an interior space within a said container in the received position in the receiving location.

20. A method for flow cytometry evaluation, the method comprising:
flowing a fluid sample through an investigation zone of a flow cytometry investigation system with a downstream end of the investigation zone being in fluid communication with a sample effluent system comprising:
an effluent collection vessel with an effluent fluid inlet for receiving an effluent of the fluid sample exiting the investigation zone during a flow cytometry evaluation, and
an effluent fluid conduction path from the investigation zone to the effluent fluid inlet:
performing a flow cytometry investigation of a flow of the fluid sample in the investigation zone:
conducting an effluent of the fluid sample exiting the investigation zone through the effluent fluid conduction path to the effluent collection vessel where the effluent of the fluid sample is collected; and
during the flowing the fluid sample through the investigation zone, applying pressurized gas to pressurize at least a portion of the fluid sample effluent system to impede fluid flow through the effluent fluid conduction path toward the effluent fluid inlet of the effluent collection vessel.

21. The method of claim 20, further comprising:
providing the fluid sample to the investigation zone through a fluid sample conduction path, wherein the fluid sample conduction path, the investigation zone, the effluent fluid conduction path and the effluent collection vessel comprise a pressurized fluidics system with fluid flow through the fluidics system in a direction toward the effluent collection vessel impeded by a back pressure from the applied gas pressure.

22. The method of claim 21, further comprising:
flow cytometry evaluation of a plurality of the fluid samples, the flow cytometry evaluation comprising withdrawing the plurality of the fluid samples from a plurality of sample containers by an autosampler and delivering the plurality of the fluid samples to the investigation zone for performance of the flow cytometry investigation on each of the plurality of the fluid samples, and wherein:
during the withdrawing, the plurality of the sample containers are at a higher elevation than a highest elevation in the investigation zone.

23. The method of any one of claims 20-22, wherein:
the flow cytometry investigation system includes an optical processing system supported on an optical component mounting member, the optical processing system comprising a flow cell with the investigation zone, an inlet light focusing element of the input light conduction path to focus the input light prior to the investigation zone and a light detection system to detect response radiation from the investigation zone, and
the method comprises controlling a temperature of the optical component mounting member with a temperature control system at the direction of a controller unit, wherein the controlling comprises
periodically collecting by the controller unit a temperature determination data set comprising first and second said digital outputs corresponding to a temperature sensor reading and a reference reading, respectively, wherein the collecting the temperature determination data set comprises:
first directing electrical current to acquire, after a first signal settling period following commencement of the first directing, a first said digital output corresponding to a said sensor reading, and
after the acquiring the first said digital output, a second directing electrical current to acquire, after a second settling period following the second commencement of the second directing, a second said digital output corresponding to a said reference reading.

24. The method of any one of claims 20-23, wherein the method is performed in the flow cytometry evaluation system of any one of claims 1-19.

25. Use of the flow cytometry evaluation system of any one of claims 1-19 to perform a flow cytometry evaluation of a fluid sample.
